(19) United States
(12) Patent Application Publication
(10) Pub. No.: US 2024/0129529 A1
(43) Pub. Date: Apr. 18, 2024

(54) IMAGE PROCESSING DEVICE AND METHOD

(71) Applicant: Sony Group Corporation, Tokyo (JP)

(72) Inventors: Kao HAYASHI, Kanagawa (JP); Satoru KUMA, Tokyo (JP); Ohji NAKAGAMI, Tokyo (JP); Tsuyoshi KATO, Kanagawa (JP); Koji YANO, Tokyo (JP)

(73) Assignee: Sony Group Corporation, Tokyo (JP)

(21) Appl. No.: 18/277,016

(22) PCT Filed: Jan. 19, 2022
(86) PCT No.: PCT/JP2022/001801

§ 371 Date: Aug. 11, 2023

(30) Foreign Application Priority Data
Mar. 22, 2021 (JP) 2021-047359

(51) Int. Cl. H04N 19/597; H04N 19/85

(52) U.S. Cl. CPC H04N 19/597; H04N 19/85

(57) ABSTRACT

There is provided an image processing device and method capable of suppressing an increase in the amount of coding. A spraying attribute projection image, which is used for spraying for adding an attribute to a geometry in the reconstruction of 3D data in a three-dimensional space, is generated by projecting an attribute of 3D data representing an object in a three-dimensional shape onto a two-dimensional plane independently of the projection of the geometry of the 3D data onto the two-dimensional plane, and coding is performed on a frame image in which the spraying attribute projection image is disposed. The present disclosure can be applied to, for example, an image processing device, an electronic device, an image processing method, or a program or the like.

### TECHNICAL FIELD

The present disclosure relates to an image processing device and method and particularly to an image processing device and method capable of suppressing an increase in the amount of coding.

### BACKGROUND ART

Conventionally, as a coding method for a point cloud in which an object in a three-dimensional form is represented as a group of points, a method (hereinafter also referred to as a video-based approach) is proposed to project the geometry and attribute of a point cloud onto a two-dimensional plane for each small area, arrange an image (patch) projected onto the two-dimensional plane in a frame image of a video, and codes the frame image according to a coding method for a two-dimensional image (see, for example, NPL 1 to NPL 4).

Furthermore, in the video-based approach, a multi-attribute method as a scheme for providing a plurality of attributes for a single geometry (single point) has been proposed (see, for example, NPL 5).

Moreover, a method of suppressing the occurrence of a point loss by projecting the connection component of a point cloud in multiple directions has been examined (see, for example, PTL 1).

### CITATION LIST

### Non Patent Literatures

[NPL 1]
“Information technology—Coded Representation of Immersive Media—Part 5: Video-based Point Cloud Compression”, ISO/IEC 23090-5:2019(E), ISO/IEC JTC 1/SC 29/WG 11 N18888
[NPL 2]
Tim Golla and Reinhard Klein, “Real-time Point Cloud Compression”, IEEE, 2015
[NPL 3]
K. Mammou, “Video-based and Hierarchical Approaches Point Cloud Compression”, MPEG m41649, October 2017
[NPL 4]
K. Mammou, “PCC Test Model Category 2 v0”, N17248 MPEG output document, October 2017
[NPL 5]
Maja Krivoku.a, Philip A. Chou, and Patrick Savill, “8i Voxelized Surface Light Field (8iVSLF) Dataset”, ISO/IEC JTC1/SC29/WG11 MPEG2018/m42914, July 2018, Ljubljana

### PATENT LITERATURE

[PTL 1]
WO 2020/137603

### SUMMARY

### Technical Problem

In any of the methods described in the literatures, however, the patch of an attribute corresponds to the patch of a geometry, leading to difficulty in independently projecting the attribute and the geometry onto a two-dimensional plane. Thus, it is difficult to divide the geometry and the attribute into more efficient small areas and project and code the geometry and the attribute on a two-dimensional plane. This may increase the amount of coding.

The present disclosure has been devised in view of such circumstances and is intended to suppress an increase in the amount of coding.

### Solution to Problem

An image processing device according to an aspect of the present technique is an image processing device including: a projection image generation unit that generates a spraying attribute projection image, which is used for spraying for adding an attribute to a geometry in the reconstruction of 3D data in a three-dimensional space, by projecting an attribute of 3D data representing an object in a three-dimensional shape onto a two-dimensional plane independently of the projection of a geometry of the 3D data onto the two-dimensional plane, and a coding unit that codes a frame image in which the spraying attribute projection image is disposed.

An image processing method according to an aspect of the present technique is an image processing method including: generating a spraying attribute projection image, which is used for spraying for adding an attribute to a geometry in the reconstruction of 3D data in a three-dimensional space, by projecting an attribute of 3D data representing an object in a three-dimensional shape onto a two-dimensional plane independently of the projection of a geometry of the 3D data onto the two-dimensional plane, and coding a frame image in which the spraying attribute projection image is disposed.

An image processing device according to another aspect of the present technique, an image processing device including: a decoding unit that decodes coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, 3D data being projected on a two-dimensional plane independent of the two-dimensional plane of the geometry projection image, a reconstruction unit that reconstructs the 3D data on the geometry in a three-dimensional space on the basis of the coded data on the geometry frame image, and a spraying unit that performs spraying to add the attribute obtained from the attribute frame image to the 3D data on the geometry in the three-dimensional space on the basis of the position and orientation of the attribute projection image.

An image processing method according to another aspect of the present technique is an image processing method including: decoding coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image, reconstructing the 3D data on the geometry in a three-dimensional space on the basis of the coded data on the geometry frame image, and performing spraying to add the attribute obtained from the attribute frame image to the 3D data on the geometry in the three-dimensional space on the basis of the position and orientation of the attribute projection image.

In the image processing device and method according to an aspect of the present technique, a spraying attribute projection image, which is used for spraying for adding an attribute to a geometry in the reconstruction of 3D data in a three-dimensional space, is generated by projecting an attribute of 3D data representing an object in a three-dimensional shape onto a two-dimensional plane independently of the projection of a geometry of the 3D data onto the two-dimensional plane, and coding is performed on a frame image in which the spraying attribute projection image is disposed.

In an image processing device and method according to another aspect of the present technique, decoding is performed on coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image, the 3D data on the geometry is reconstructed in a three-dimensional space on the basis of the coded data on the geometry frame image, and spraying is performed to add the attribute obtained from the attribute frame image to the 3D data on the geometry in the three-dimensional space on the basis of the position and orientation of the attribute projection image.

### BRIEF DESCRIPTION OF DRAWINGS

FIG. 1 is an explanatory drawing of a video-based approach.

FIG. 2 is an explanatory drawing of the video-based approach.

FIG. 3 is an explanatory drawing of recoloring.

FIG. 4 is an explanatory drawing of patches.

FIG. 5 is an explanatory drawing illustrating an example of spraying.

FIG. 6 is an explanatory drawing illustrating an example of spraying.

FIG. 7 is an explanatory drawing illustrating an example of spraying textures.

FIG. 8 is an explanatory drawing of a spraying patch.

FIG. 9 is an explanatory drawing illustrating an example of spraying.

FIG. 10 is an explanatory drawing illustrating an example of spraying.

FIG. 11 is an explanatory drawing illustrating an example of spraying.

FIG. 12 is an explanatory drawing illustrating an example of spraying.

FIG. 13 is an explanatory drawing illustrating an example of spraying.

FIG. 14 is an explanatory drawing illustrating an example of spraying.

FIG. 15 is an explanatory drawing illustrating an example of transmission information.

FIG. 16 is an explanatory drawing illustrating an example of spraying.

FIG. 17 is an explanatory drawing illustrating an example of spraying.

FIG. 18 is an explanatory drawing illustrating an example of spraying.

FIG. 19 is a block diagram illustrating a main configuration example of a coding device.

FIG. 20 is a flowchart for explaining an example of a flow of coding.

FIG. 21 is a block diagram illustrating a main configuration example of a decoding device.

FIG. 22 is a flowchart for explaining an example of a flow of decoding.

FIG. 23 is an explanatory drawing illustrating an example of multi-attribute.

FIG. 24 is an explanatory drawing illustrating an example of multi-attribute.

FIG. 25 is an explanatory drawing illustrating an example of transmission information.

FIG. 26 is an explanatory drawing illustrating an example of transmission information.

FIG. 27 is an explanatory drawing illustrating an example of a spraying texture frame.

FIG. 28 is an explanatory drawing illustrating an example of the spraying texture frame.

FIG. 29 is an explanatory drawing illustrating an example of the spraying texture frame.

FIG. 30 is a block diagram illustrating a main configuration example of a computer.

### DESCRIPTION OF EMBODIMENTS

Hereinafter, modes for carrying out the present disclosure (hereinafter referred as embodiments) will be described. The descriptions will be given in the following order.

1. Overview of Video-Based Approach

2. Spraying

3. First Embodiment (Coding Device)

4. Second Embodiment (Decoding Device)

5. Multi-Attribute Case

6. Supplement

<1. Overview of Video-Based Approach>

<Literatures That Support Technical Content and Terms>

The scope disclosed in the present technique is not limited to the contents described in the embodiments and also includes the contents described in the following NPL and the like that were known at the time of filing and the contents of other literatures referred to in the following NPL.

[NPL 1]

(Aforementioned)

[NPL 2]

(Aforementioned)

[NPL 3]

(Aforementioned)

[NPL 4]

(Aforementioned)

[NPL 5]

(Aforementioned)

[PTL 1]

(Aforementioned)

In other words, the contents in the NPL and the contents of other literatures referred to in the above NPL are also grounds for determining support requirements.

<Point Cloud>

In the related art, 3D data such as a point cloud is present, the 3D data representing a three-dimensional structure with, for example, point position information or attribute information.

In the case of a point cloud, for example, a stereoscopic structure (an object in a three-dimensional shape) is expressed as a group of multiple points. The point cloud includes position information at each point (also referred to as a geometry) and attribute information (also referred to as an attribute). The attribute can include any information. For example, the attribute may include color information, reflectance information, and normal line information at each point. Thus, the point cloud has a relatively simple data structure and can represent any stereoscopic structure with sufficient accuracy by using a sufficiently large number of points.

<Video-Based Approach>

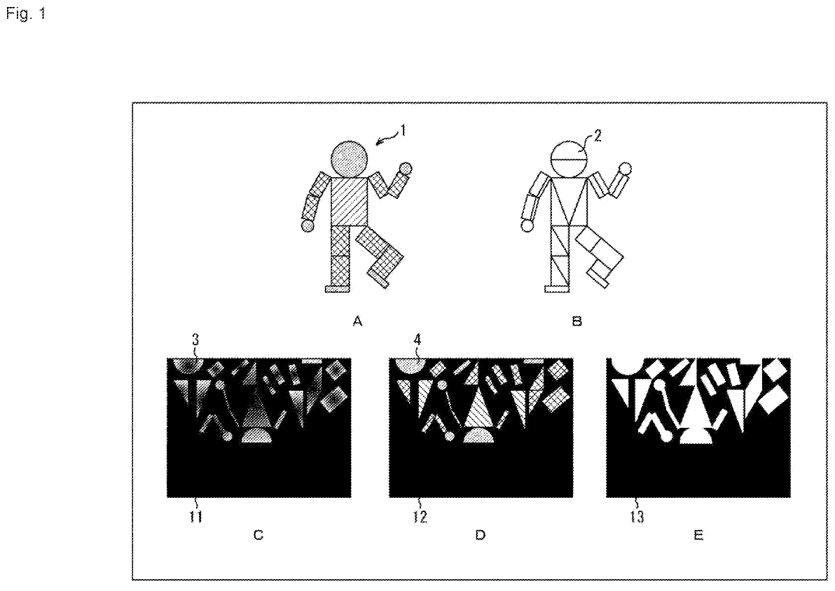

In a video-based approach, a geometry and an attribute of such a point cloud are projected to a two-dimensional plane for each small area (connection component). In the present disclosure, the small area may be referred to as a partial area. An image in which the geometry and the attribute are projected to the two-dimensional plane will also be referred to as a projection image. The projection image for each small area (partial area) will be referred to as a patch. For example, an object 1 (3D data) in A of FIG. 1 is decomposed into patches 2 (2D data) as illustrated in B of FIG. 1. For geometry patches, each pixel value indicates position information at a point. However, in this case, the position information at a point is represented as position information (depth value (Depth)) in the vertical direction (depth direction) with respect to the projection plane.

Each patch generated thus is then arranged in a frame image of a video sequence (also referred to as a video frame). A frame image in which geometry patches are arranged is also referred to as a geometry video frame. Furthermore, a frame image in which attribute patches are arranged is also referred to as an attribute video frame. For example, from the object 1 in A of FIG. 1, a geometry video frame 11 including geometry patches 3 as illustrated in C of FIG. 1 and an attribute video frame 12 including attribute patches 4 as illustrated in D of FIG. 1 are generated. For example, each pixel value of the geometry video frame 11 indicates the foregoing depth value.

These video frames are coded by using a coding method for a two-dimensional image, for example, advanced video coding (AVC) or high efficiency video coding (HEVC). In other words, the point cloud data, which is 3D data representing a three-dimensional structure, can be coded by using a codec for a two-dimensional image.

<Occupancy Map>

In the case of such a video-based approach, an occupancy map can also be used. The occupancy map is map information indicating the presence or absence of a projection image (patch) for each of the N×N pixels of a geometry video frame or an attribute video frame. For example, in the occupancy map, an area (N×N pixels) with a patch in the geometry video frame or the attribute video frame is indicated by a value “1”, whereas an area (N×N pixels) with no patches is indicated by a value “0”.

Such an occupancy map is coded as data different from the geometry video frame or the attribute video frame and is then transmitted to a decoding side. Since a decoder can recognize whether patches are present in the area with reference to the occupancy map, the influence of noise or the like generated by coding/decoding can be suppressed and 3D data can be more accurately restored. Even if a depth value is changed by coding/decoding, for example, the decoder can ignore a depth value (avoid processing of the depth value as position information about the 3D data) in an area having no patches with reference to the occupancy map.

For example, for the geometry video frame 11 and the attribute video frame 12, an occupancy map 13 may be generated as illustrated in E of FIG. 1. In the occupancy map 13, a white portion indicates a value “1” and a black portion indicates a value “0”.

The occupancy map can also be transmitted as a video frame, like the geometry video frame and the attribute video frame or the like.

<Auxiliary Patch Information>

Furthermore, in the case of the video-based approach, information on a patch (also referred to as auxiliary patch information) is transmitted as metadata.

<Video Image>

In the following description, it is assumed that (an object of the point cloud can change in a direction of time, like a two-dimensional moving image. In other words, geometry data and attribute data have a concept of time direction and is sampled at predetermined time intervals like a two-dimensional moving image. Data at each sampling time is referred to as a frame like a video frame of a two-dimensional image. In other words, it is assumed that the point cloud data (the geometry data or attribute data) includes a plurality of frames like a two-dimensional moving image. In the present disclosure, a frame of the point cloud is also referred to as a point cloud frame. In the case of the video-based approach, by converting each point cloud frame into a video frame to obtain a video sequence, such a point cloud of a moving image (a plurality of frames) can be efficiently coded using a moving image encoding scheme.

<Dependence of Geometry and Attribute>

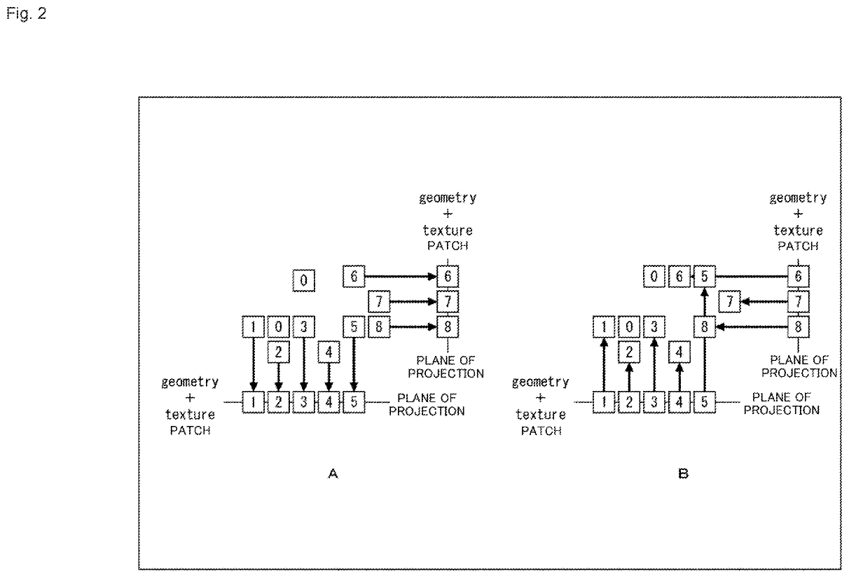

In a conventional method, however, a geometry and an attribute at the same position in a projection image are associated with each other. Specifically, upon patching, a geometry and an attribute at each point are divided into similar small areas as indicated by arrows in A of FIG. 2 and are projected for each of the small areas onto the same plane of projection. In FIG. 2, each square indicates the geometry and attribute (texture) of one point. The position of each square indicates a geometry while a number in each square indicates an example of an attribute (texture). Thus, in the reconstruction of 3D data, a geometry and an attribute at the same position on the plane of projection are combined as information about one point.

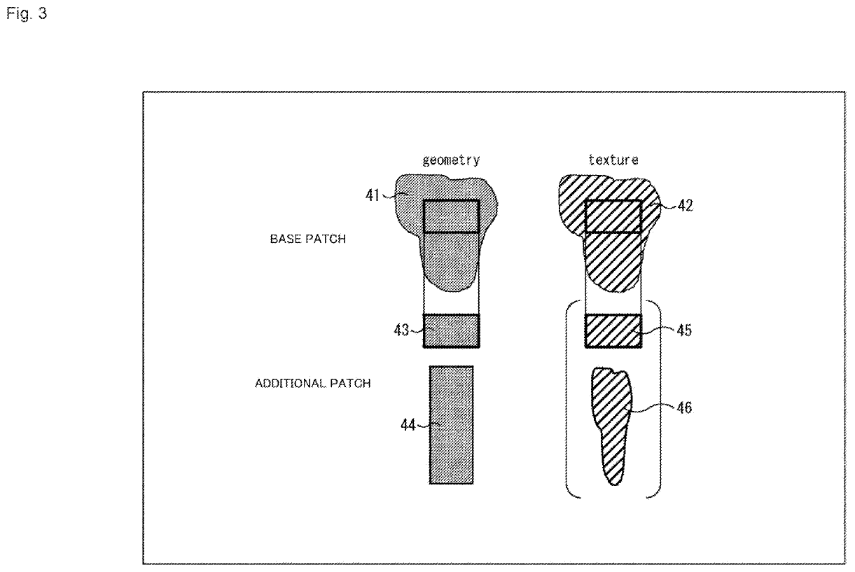

As described above, the geometry and the attribute are divided into similar small areas like patches. From a conventional arrangement for reconstructing a point cloud, it has been difficult to independently divide the geometry and the attribute into small areas like patches. For example, as illustrated in FIG. 3, a base patch 41 of a geometry (geometry) and a base patch 42 of an attribute (texture) are identical in shape. In the method of PTL 1, patches like an additional patch 43 and an additional patch 44 can be added to a part or the overall area of the base patch 41. Also for the attribute (texture), patches like an additional patch 45 and an additional patch 46 can be added to a part or the overall area of the base patch 42, but the additional patches are identical in shape to the patches of the geometry.

Thus, it is difficult to divide the geometry and the attribute into more efficient small areas and project and code the geometry and the attribute on a two-dimensional plane. For example, in small areas where the geometry has a minimum amount of coding, the amount of coding of the attribute may increase. Conversely, in small areas where the attribute has a minimum amount of coding, the amount of coding of the geometry may increase. Thus, the amounts of coding of the geometry and the attribute cannot be always minimized, and the amount of coding may increase.

Moreover, the projection of the geometry or the attribute onto each small area is likely to cause a displacement or distortion at the seams of patches in the reconstruction of the point cloud. As described above, if the patches of the geometry and the attribute are identical in shape, a displacement or distortion of the texture is likely to occur at the same position, so that the seams of the patches may have noticeable degradation.

Since the projection direction of the attribute is set according to the projection direction of the geometry it may be difficult to project the attribute in the optimum direction with respect to the position of a viewpoint and the direction of a line of sight. Thus, a display image that is a 2D image indicating a view from the position of a viewpoint may suffer a loss of image quality, for example, a distortion of the texture may be increased by a mismatch between the projection directions.

Moreover, the value of the geometry can be changed by coding and decoding or smoothing or the like. As described above, in the reconstruction of the point cloud, data pieces of the geometry and the attribute at the same position are associated with each other on the plane of projection, so that a change of the point position may relocate the attribute (texture). For example, as indicated in B of FIG. 2, a texture “8” may be placed at the location of a texture “5” in A of FIG. 2 or a texture “5” may be placed at the location of a texture “6” in A of FIG. 2. Such a relocation of the texture may change the appearance of the object. In other words, the image quality of a display image may deteriorate.

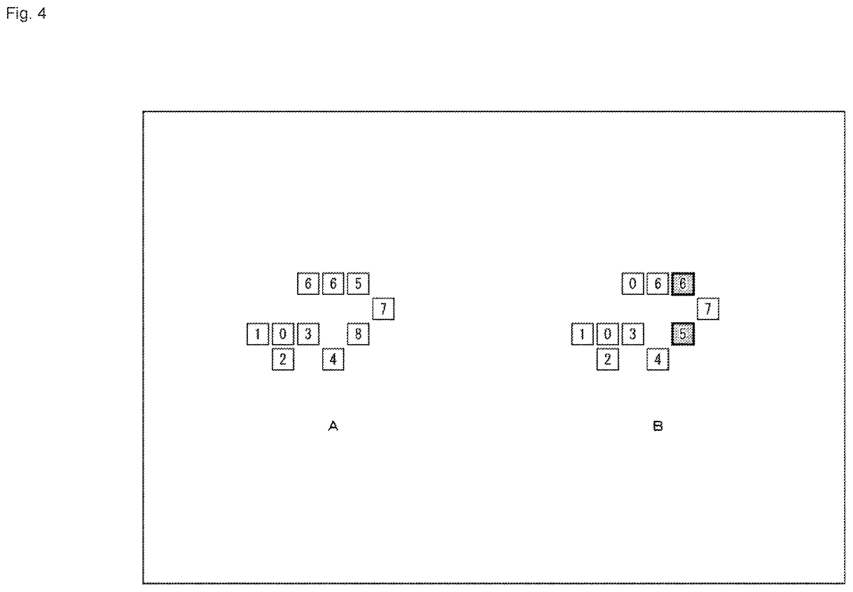

Thus, recoloring is performed in coding or decoding. Recoloring is processing in which the attribute (texture) of a point to be processed is processed with reference to surrounding points or the like. For example, a texture “5” in A of FIG. 4 is changed to a texture “6” as shown in B of FIG. 4. Moreover, a texture “8” in A of FIG. 4 is changed to a texture “5” as shown in B of FIG. 4. These changes can bring the positions of the textures close to a state in A of FIG. 2 (a state before coding). In short, a loss of the image quality of the display image can be suppressed.

As described above, the conventional method of reconstructing a point cloud (associating a geometry and an attribute) requires recoloring for suppressing a loss of the image quality of a display image. Recoloring has a heavy load and thus may increase a load for reproducing 3D data (processing for decoding a bit stream to reconstruct 3D data and generate a display image).

For example, at a point having a high reflectance, a texture may considerably change depending upon the position of a viewpoint (the direction of a line of sight). Hence, in NPL 5, a method of providing a plurality of attributes (multi attribute) for a single geometry (single point) is proposed. By associating a plurality of attributes with a single geometry, a more proper attribute can be selected at the time of rendering or a more proper attribute can be generated using a plurality of attributes, thereby suppressing a loss of the subjective image quality of a display image. However, an attribute is formed for each camera and thus an object having such a local feature may cause coding of an unnecessary attribute (an attribute in an area having a low reflectance). Therefore, the amount of coding may increase with a redundant information content.

<2. Spraying>

<Spraying>

Thus, in the reconstruction of 3D data, a geometry and an attribute are associated with each other by “spraying” in which an attribute is associated with a geometry in a three-dimensional space.

For example, in an image processing method, decoding is performed on coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image, the 3D data on the geometry is reconstructed in a three-dimensional space on the basis of the coded data on the geometry frame image, and spraying is performed to add the attribute obtained from the attribute frame image to the 3D data on the geometry in the three-dimensional space on the basis of the position and orientation of the attribute projection image.

For example, an image processing device includes a decoding unit that decodes coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image, a reconstruction unit that reconstructs the 3D data on the geometry in a three-dimensional space on the basis of the coded data on the geometry frame image, and a spraying unit that performs spraying to add the attribute obtained from the attribute frame image to the 3D data on the geometry in the three-dimensional space on the basis of the position and orientation of the attribute projection image.

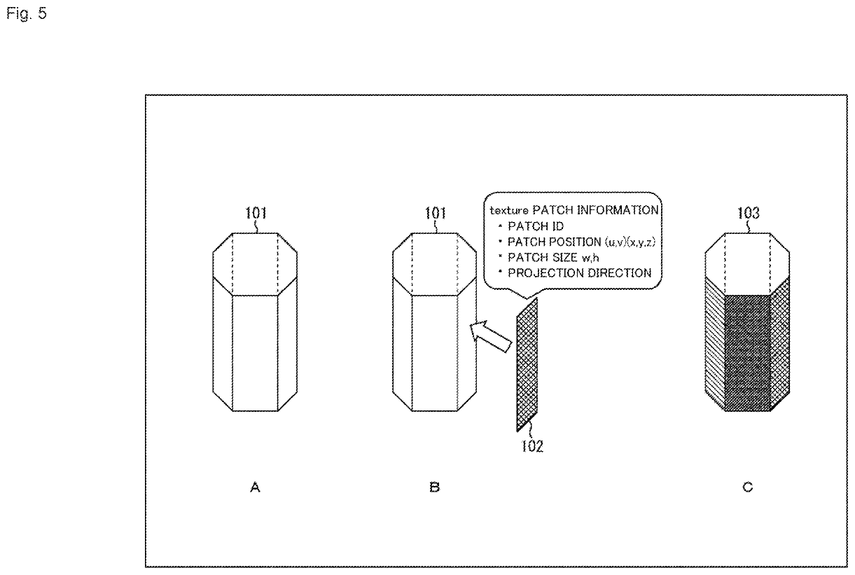

For example, as shown in A of FIG. 5, an object 101 having a three-dimensional shape is formed (reconstructed) by placing a geometry in a three-dimensional space. In this state, the object 101 only includes position information and coloring is not performed on textures or the like. For example, in the case of a point cloud, the object 101 is configured with a set of points (only geometries).

Thereafter, as shown in B of FIG. 5, a texture patch 102 (attribute) is added to the object 101 (the geometry and the attribute are associated with each other) in the three-dimensional space. In short, the object 101 is subjected to coloring or the like. Hereinafter, a texture (e.g., a color) is used as an example of the attribute.

At this point, the patch 102 is added on the basis of the position and orientation of the projection image (that is, the attribute projection image) of the patch 102. Information (texture patch information) about the patch 102 is associated with the patch 102. For example, the information may include identification information (patch ID) about the patch 102, information indicating the position of the patch 102 in a three-dimensional space or a two-dimensional space, information indicating the size of the patch 102, and information indicating the projection direction of the patch 102.

The patches of textures are added to the object 101 like the patch 102, so that 3D data 103 including a geometry and an attribute is reconstructed as shown in C of FIG. 5.

For example, a texture on a projection image may be added in the projection direction (in the direction opposite to the projection direction) with respect to an object. In other words, an attribute on an attribute projection image may be added to part of 3D data on a geometry located in the projection direction of the attribute in a three-dimensional space. In this case, data on each texture disposed on the projection image is added to a geometry (point) located ahead in the projection direction (in the direction opposite to the projection direction). The projection direction may be perpendicular to the projection image. In other words, each texture on the projection image may be added to a geometry located perpendicularly to the projection image.

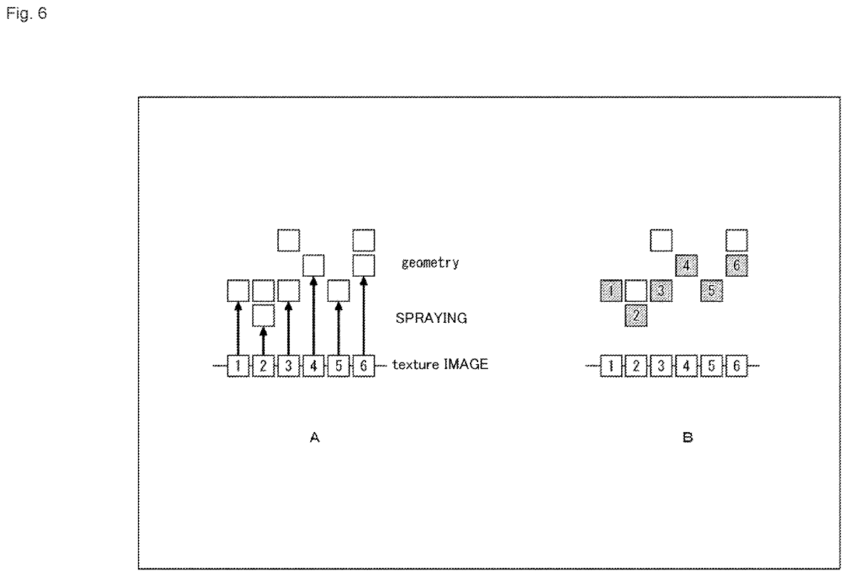

For example, as indicated in A of FIG. 6, a texture image (projection image) is sprayed onto a geometry, and data on the texture image is added to the geometry located ahead in the direction of an arrow perpendicular to the texture image. For example, as indicated in B of FIG. 6, data on a texture may be added to a geometry closest to a texture image among geometries located in the projection direction in a three-dimensional space. In other words, an attribute on an attribute projection image may be added to a portion, which is closest to the attribute projection image in the projection direction of the attribute in the three-dimensional space, among the 3D data pieces of the geometries.

The reconstruction of 3D data (the addition of an attribute to a geometry) by spraying eliminates the need for correspondence between an attribute and a geometry at the same position in a state of a projection image. Thus, the attribute can be projected to a two-dimensional plane independently of the geometry and can be coded thereon.

In other words, the small areas of the geometry and the attribute can be independently set. For example, the small areas of the geometry and the attribute can be set in such a manner as to reduce the amount of coding. In other words, coding of unnecessary information can be suppressed. This can curb an increase in the amount of coding.

In the case of spraying, an attribute (texture) is associated with a geometry disposed in a three-dimensional space, eliminating the need for recoloring. For example, also when the position of a point is changed, an attribute can be associated with a geometry after the geometry is corrected on the basis of surrounding points. This can suppress an increase in the load of reproduction of 3D data.

<Generation of Spraying Texture>

For example, in an image processing method, a spraying attribute projection image, which is used for spraying for adding an attribute to a geometry in the reconstruction of 3D data in a three-dimensional space, is generated by projecting an attribute of 3D data representing an object in a three-dimensional shape onto a two-dimensional plane independently of the projection of a geometry of the 3D data onto the two-dimensional plane, and coding is performed on a frame image in which the spraying attribute projection image is disposed.

For example, an image processing device includes a projection image generation unit that generates a spraying attribute projection image, which is used for spraying for adding an attribute to a geometry in the reconstruction of 3D data in a three-dimensional space, by projecting an attribute of 3D data representing an object in a three-dimensional shape onto a two-dimensional plane independently of the projection of a geometry of the 3D data onto the two-dimensional plane, and a coding unit that codes a frame image in which the spraying attribute projection image is disposed.

Thus, the small areas of the geometry and the attribute can be independently set. This can suppress coding of unnecessary information and an increase in the amount of coding.

The shapes and numbers of the patches of geometries and attributes can be independently set. Specifically, the spraying attribute projection image may be generated by projecting an attribute onto a two-dimensional plane in such a manner as to form a partial area independent of a partial area of the projection of a geometry. For example, the spraying attribute projection image may be generated by projecting an attribute with a predetermined area onto a two-dimensional plane independently of a small area of a geometry.

<Spraying Texture>

Hereinafter, a texture associated with a geometry by spraying will be also referred to as a spraying texture. The range of the spraying texture (the range of an object to be subject to spraying) is arbitrarily set. The range may be the overall object (geometry) or a part of the object. For example, in the case of a point cloud, all points may be colored by spraying or only some of the points may be colored by spraying. In this case, other points may be colored by associating a geometry and an attribute at the same position on a projection image (that is, by reconstructing 3D data using a base patch).

In the case of spraying on a part of an object, the range may be signaled. In other words, information about a range to be subjected to spraying may be coded and transmitted to the decoding side. The range is specified by any method. For example, a range to be subject to spraying may be specified by a bounding box (e.g., (x1, y1, z1), (x2, y2, z2)). Alternatively, a range to be subject to spraying may be specified by using the threshold values of coordinates (e.g., y>theta, theta1<y<theta2). Moreover, an ID list of points to be subjected to spraying may be signaled (e.g., {1, 2, 4, 7, 8}). Alternatively, an ID list of the patches of geometries to be subjected to spraying may be signaled (e.g., ID=1, 2).

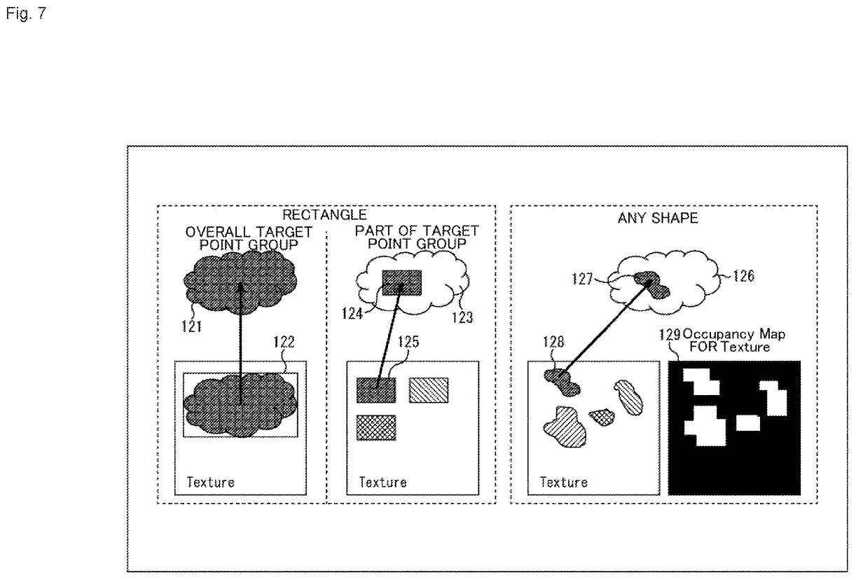

A spraying texture may be projected for each small area or may be projected without being divided into small areas. In other words, patching may be omitted. A spraying texture may be rectangular. For example, as illustrated in FIG. 7, a rectangular spraying texture 122 including an object 121 (overall target point group) may be generated. In this case, spraying is performed on the overall object 121 by using the spraying texture 122. Moreover, a spraying texture 125 may be generated for a rectangular area 124 in a part of an object 123 (target point group). In the case of a rectangular spraying texture, the range of a projection image (including patches) can be easily specified only by texture patch information described with reference to FIG. 5 (an occupancy map is not necessary).

The spraying texture may have any shape. For example, a spraying texture 128 may be generated for an area 127 in any shape in a part of an object 126. In this case, the spraying texture 128 is formed in any shape and thus an occupancy map (an occupancy map independent of an occupancy map corresponding to a geometry) 129 specific for the spraying texture may be generated.

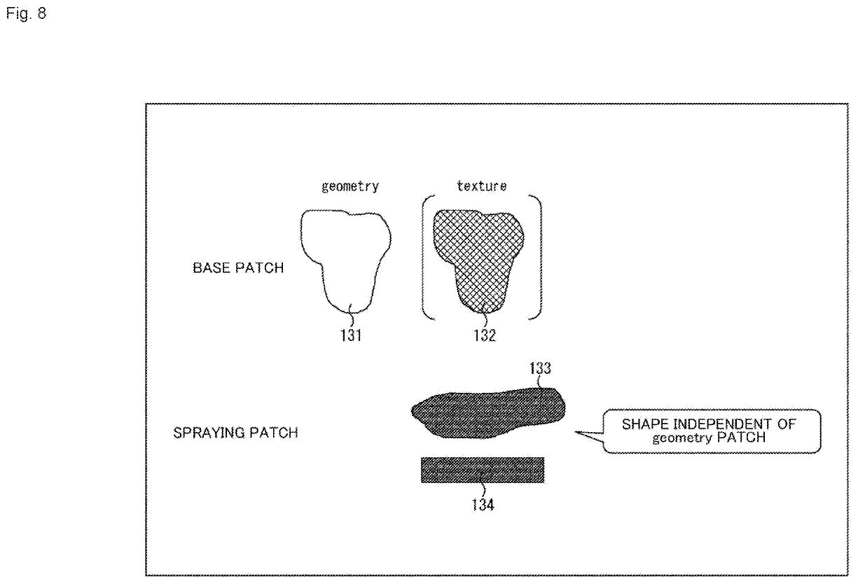

For example, as illustrated in FIG. 8, a patch 133 and a patch 134 for spraying textures (also referred to as spraying patches) may have shapes independently of a patch 131 of a geometry. In other words, the spraying patch may have a different shape from a patch of a geometry. In addition to the spraying patches (the patch 133 and the patch 134), a patch 132 with a texture corresponding to the patch 131 of the geometry may be provided on a projection image. In other words, a patch with an attribute (texture) identical in shape to the patch of the geometry may be provided. For example, the patch of such a geometry and the patch of an attribute identical in shape to the patch of the geometry may be used as base patches in which the geometries and attributes of overall 3D data are patched, and the spraying patch may be an additional patch used in addition to the base patch. In other words, the attribute of a spraying patch may be added to 3D data (geometry) with an additional attribute by spraying. In this case, for example, in reconstruction for reconstructing 3D data from patches, the overall 3D data (the geometries and attributes of 3D data) may be reconstructed by using base patches (e.g., the patch 131 and the patch 132) and the texture of the spraying patch (e.g., the patch 133 or the patch 134) may be sprayed to a desired location in the reconstructed 3D data during spraying. The base patch of the attribute is also referred to as a base attribute patch (or a base attribute projection image).

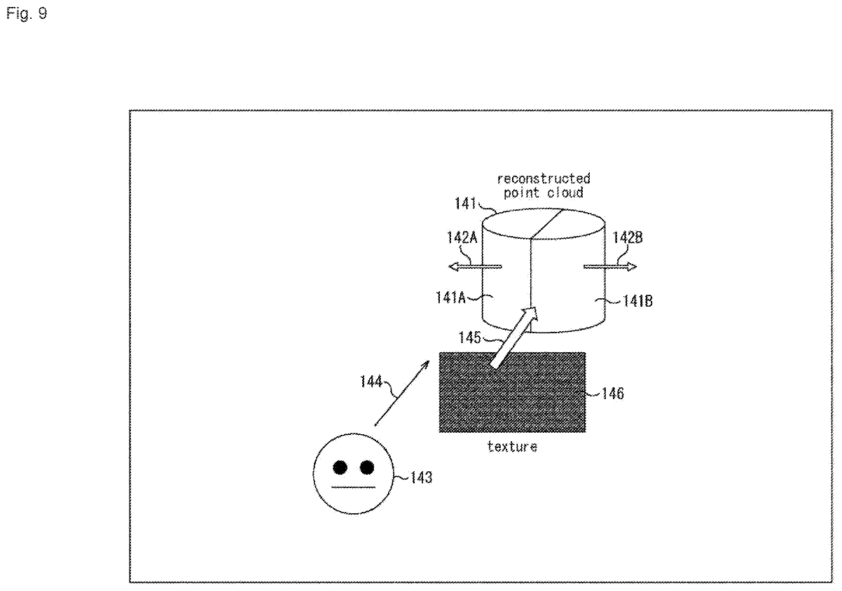

For example, as illustrated in FIG. 9, ranges corresponding to the patch of a geometry and a spraying patch, respectively, may be displaced from each other. One of the ranges may avoid including the other range. In the example of FIG. 9, a geometry 141 is divided into a small area 141A as a left half and a small area 141B as a right half. The texture of a spraying patch 146 is sprayed to the geometry 141 in the direction of an arrow 145. Thus, in this case, the spraying range of the spraying patch 146 extends across the boundary between the small area 141A and the small area 141B. In this way, the ranges of patch of a geometry and a spraying patch may be displaced from each other or one of the ranges may avoid including the other.

In other words, the spraying range of the spraying patch 146 includes the border of the small area of the geometry. Thus, a spraying attribute projection image (that is, the spraying patch 146) may be generated by projecting the attribute of the area including the border of the small area of the geometry to the two-dimensional plane. Thus, the border of the small area (patch) of the geometry and the border of the small area (patch) of the texture can be displaced from each other. This can reduce a displacement or a distortion at the seams of patches (reduce the noticeability).

For example, for a geometry, an area having a similar normal line is used as a patch in order to prevent a loss at a point in an occlusion area, a base color patch for a texture can be generated in the same shape as the geometry, and a patch for a spraying texture projected at a different angle can be generated and used for correcting a location (e.g., a patch border) where the texture of a base color is considerably distorted. Thus, a loss of the subject image quality of a display image can be suppressed.

Alternatively, a spraying attribute projection image may be generated by projecting an attribute in a projection direction independent of the projection direction of a geometry. For example, in FIG. 9, the small area 141A is projected in the direction of an arrow 142A. Furthermore, the small area 141B is projected in the direction of an arrow 142B. In contrast, the spraying texture is projected in a sight line direction 144 of a user 143 (in the direction opposite to the sight line direction), the sight line direction 144 being different from these direction (the projection direction of the geometry).

For the geometry, patches can be finely generated in order to prevent a loss at a point in the occlusion area. For the texture, patches can be generated in large units like an image from a camera so as to correspond to the position of a viewpoint and the sight line direction regardless of the projection direction of the geometry. Thus, seams or the like can be less noticeable at patches in a display image, and a loss of the subject image quality of the display image can be suppressed.

<Coloring>

In spraying, a point to be colored is determined from points to be subjected to spraying. A signal may be transmitted to indicate a method of determining a point to be colored.

For example, coloring may be performed only on a point closest to the plane of projection of the texture, that is, the nearest portion of the geometry. Alternatively, the same color may be applied to multiple points superimposed in the projection direction. In other words, an attribute on a spraying attribute projection image may be added to a plurality of portions (points), which include the nearest portion with respect to the spraying attribute projection image corresponding to the projection direction of the attribute, among the 3D data pieces of the geometries.

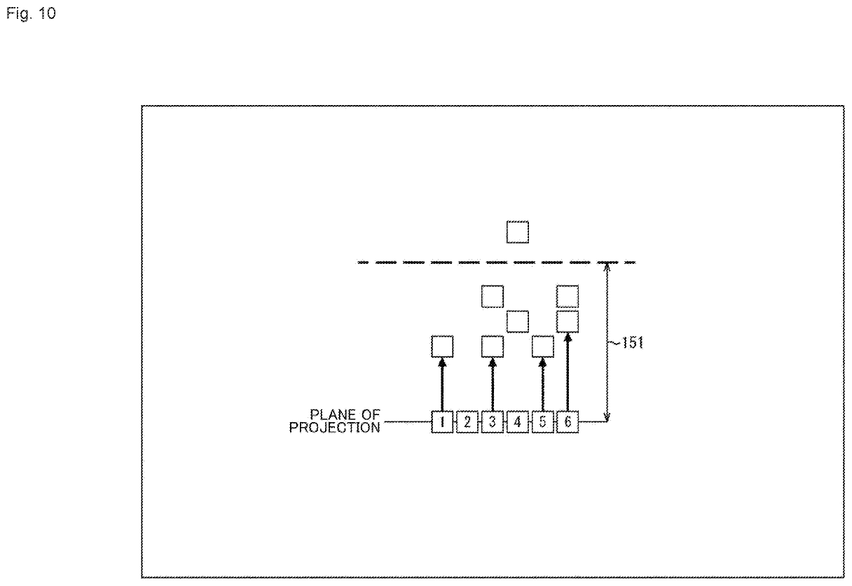

Furthermore, coloring may be performed only on a point having a depth value equal to or smaller than a predetermined threshold value from the plane of projection. In other words, an attribute on a spraying attribute projection image may be added to at least a portion, which is located in a predetermined range from the spraying attribute projection image in the projection direction of the attribute, among the 3D data pieces of the geometries. For example, in the case of FIG. 10, the spraying texture is added to geometries in a range indicated by a double-pointed arrow 151 from the plane of projection to a dotted line.

<Correction Based on Surrounding Points>

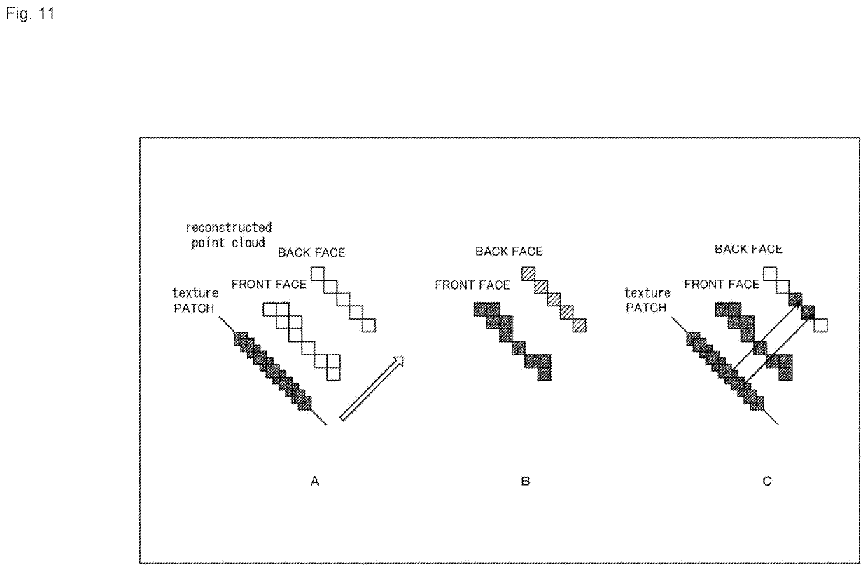

For example, in the case of projection diagonal to the surface of an object, a sparse texture may occur on the plane of projection. In this case, a method of densely increasing texture data to prevent the occurrence of a sparse texture is available. In the application of such a method, a texture may have a larger amount of data than a geometry in spraying and may be added to a geometry on the back side when viewed from the plane of projection. For example, as indicated in A of FIG. 11, it is assumed that a geometry has two faces: a back face and a front face when viewed from the plane of projection of a texture. In other words, it is assumed that two objects are present in the depth direction when viewed from the plane of projection of the texture. As indicated in B of FIG. 11, the texture (color) on the plane of projection is originally a texture (color) on the front face and the back face has a different texture (color).

In this case, the spraying texture is desirably added to the front face by spraying. However, as described above, the number of data pieces of the texture is larger than that of the geometry, which may allow a surplus texture to pass through the front face and to be added to the back face (that is, coloring on an object not to be colored). This may deteriorate the quality of 3D data.

Moreover, a deterioration or the like of the geometry may cause a gap on the surface of the object on the front side, so that the texture may pass through the object on the front side from the gap and may be added to the different object on the back side.

Thus, during spraying, a target geometry may be corrected on the basis of a geometry around the target geometry. In other words, an attribute on a spraying attribute projection image may be added to at least one of a geometry generated on the basis of a surrounding geometry and a moved target geometry in the projection direction of the attribute in a three-dimensional space.

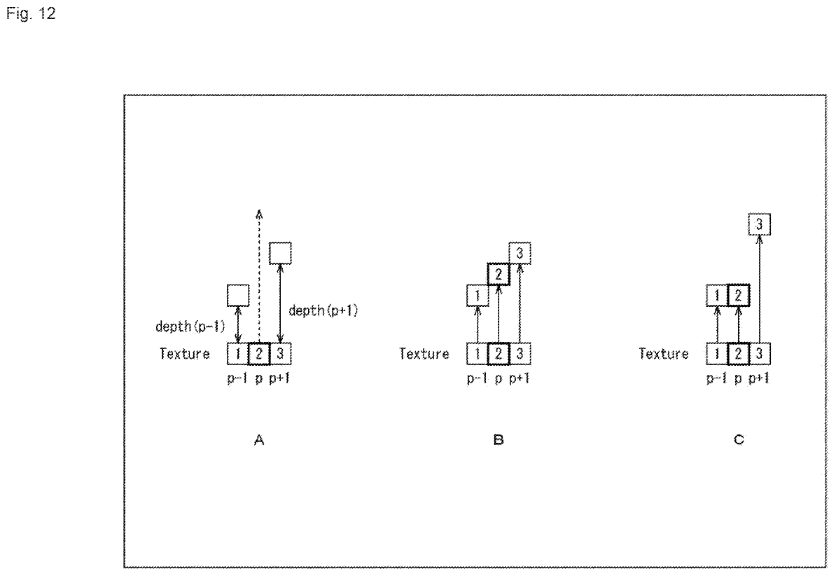

For example, as indicated in A of FIG. 12, spraying of data (p−1), p, (P+1) on a spraying texture to a point (geometry) will be described below. In the example of A in FIG. 12, it is assumed that a point (geometry) (a point located in the projection direction when viewed from the target data p) corresponding to target data p is not present. In contrast, it is assumed that a point (geometry) is present at the position of a depth value (depth(p−1)) in the projection direction of data (p−1) and a point (geometry) is present at the position of a depth value (depth(p+1)) in the projection direction of data (p+1).

For example, if it is highly likely that a point corresponding to the data (p−1) and a point corresponding to the data (p+1) are points on the same plane of an object, a point corresponding to the target data p may be generated as a point on the same plane as these points and the target data p may be sprayed to the point.

For example, if the absolute value of a difference between the depth value (depth(p−1)) and the depth value (depth(p+1)) is smaller than a predetermined threshold value, as indicated in B of FIG. 12, the average interpolation of the depth value (depth(p−1)) and the depth value (depth(p+1)) may be used as a depth value of a point corresponding to the target data p.

If(abs(depth(p−1)−depth(p+1))<Threshold) is true, the average interpolation of depth(p)=(depth(p−1),depth(p+1)

For example, if it is highly likely that a point corresponding to the data (p−1) and a point corresponding to the data (p+1) are points on different planes of an object, a point corresponding to the target data p may be generated as a point on the same plane as one of these points and the target data p may be sprayed to the point.

For example, if the absolute value of a difference between the depth value (depth(p−1)) and the depth value (depth(p+1)) is equal to or larger than the predetermined threshold value, as indicated in C of FIG. 12, the depth value of the point corresponding to the data (p−1) or the point corresponding to the data (p+1) may be duplicated and used as a depth value of a point corresponding to the target data p. In other words, the depth value (depth(p−1)) or the depth value (depth(p+1)) may be used as a depth value of a point corresponding to the target data p.

If(abs(depth(p−1)−depth(p+1))<Threshold) is false, depth(p)=depth(p+1) or depth(p+1)

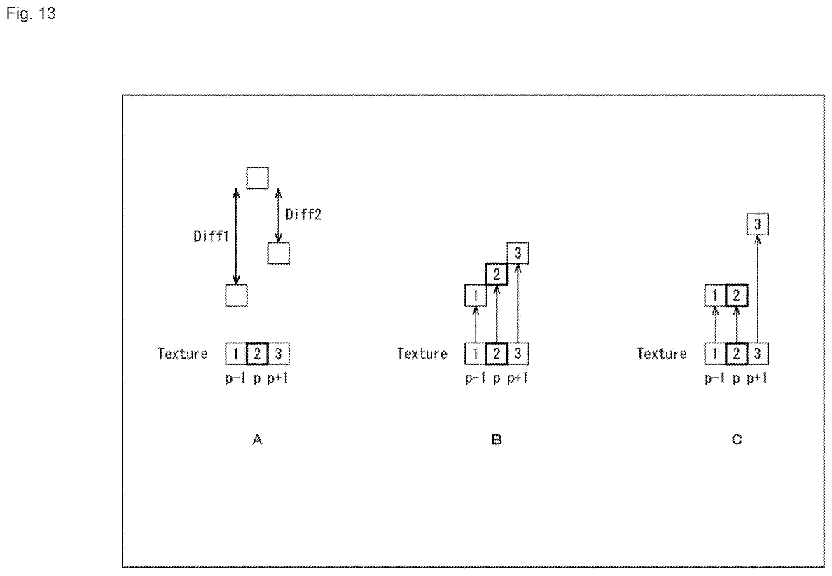

For example, as indicated in A of FIG. 13, it is assumed that a point (geometry) corresponding to the target data p is present. In this case, a difference between the depth value (depth(p)) of a point corresponding to the target data p and the depth value (depth(p−1)) of a point corresponding to the data (p−1) is denoted as Diff1, and a difference between a depth value (depth(p)) of a point corresponding to the target data p and the depth value (depth(p+1)) of the point corresponding to the data (p+1) is denoted as Diff2.

Diff1=depth(p)−depth(p−1)

Diff2=depth(p)−depth(p+1)

For example, if it is highly likely that a point corresponding to the target data p is a point on a different plane of an object from a point corresponding to the data (p−1) and a point corresponding to the data (p+1) and the point corresponding to the data (p−1) and the point corresponding to the data (p+1) are points on the same plane of the object, a point corresponding to the target data p may be generated as a point on the same plane as these points, the point may be moved to a proper position with respect to surrounding points, and the target data p may be sprayed to the point.

For example, if smaller one of Diff1 and Diff2 is larger than a predetermined threshold and the absolute value of a difference between Diff1 and Diff2 is smaller than the predetermined threshold value, as indicated in B of FIG. 13, the average interpolation of the depth value (depth(p−1)) and the depth value (depth(p+1)) may be used as a depth value of a point corresponding to the target data p.

In the case of min(Diff1,Diff2)>Threshold and abs(Diff1−Diff2)<Threshold, the average interpolation of depth(p)=(depth(p−1),depth(p+1)

For example, if it is highly likely that a point corresponding to the target data p is a point on a different plane of an object from a point corresponding to the data (p−1) and a point corresponding to the data (p+1) and the point corresponding to the data (p−1) and the point corresponding to the data (p+1) are points on different planes of the object, a point corresponding to the target data p may be generated as a point on the same plane as one of these points, the point may be moved to the same position (depth value) as the point on the same plane, and the target data p may be sprayed to the point.

For example, if smaller one of Diff1 and Diff2 is larger than a predetermined threshold and the absolute value of a difference between Diff1 and Diff2 is equal to or larger than the predetermined threshold value, as indicated in C of FIG. 13, the depth value of a point corresponding to the target data p may be used as the depth value of a point corresponding to the data (p−1) or a point corresponding to the data (p+1). In other words, the depth value (depth(p−1)) or the depth value (depth(p+1)) may be used as a depth value of the point corresponding to the target data p.

In the case of min(Diff1,Diff2)>Threshold and abs(Diff1−Diff2)<Threshold, depth(p)=depth(p+1) or depth(p+1)

In the foregoing description, two adjacent points are referred to as surrounding points. Any points may be referred to as surrounding points. Points at any positions may be referred to with respect to a point corresponding to target data, and any number of points may be referred to. Moreover, the geometry (depth value) of a point corresponding to target data may be determined by any method. The method is not limited to the example of average interpolation or duplication. Furthermore, information about the method of correcting the geometry may be signaled (coded and transmitted to the decoding side), and the geometry may be corrected by a method based on the signaled information.

<Determination of Final Color>

If a plurality of textures are present for a geometry, the texture to be added to the geometry may be determined by any method.

For example, if a base color is transmitted, the base color and a spraying texture may be synthesized (blended) by any method (e.g., a sum, an average, or a weighted average). Moreover, the base color may be repainted (overwritten) with the spraying texture.

Abase texture and a spraying texture may be identified by any method. For example, information about whether a texture is a spraying texture may be signaled (coded and transmitted to the decoding side). Alternatively, information about whether a texture is a base texture may be signaled.

In the case of a point (geometry) where a texture (color) is not added by spraying, a texture (color) at the point may be interpolated. For example, the texture (color) may be interpolated by using the texture (color) or the like at a surrounding point where a texture (color) is added. The interpolation may be performed by any method (e.g., duplication, an average, or a weighted average). The point may be provided without a texture (color). Alternatively, points (geometries) having no textures (colors) may be omitted.

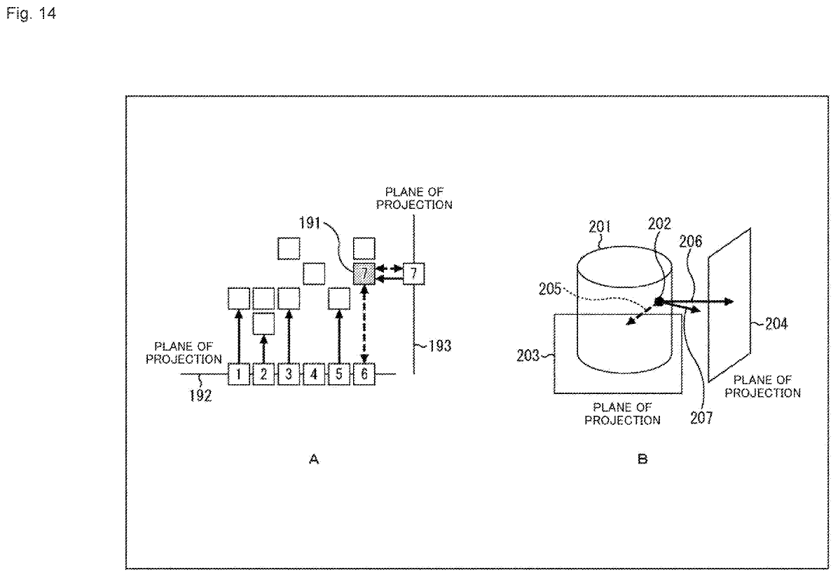

If a single point (geometry) is to be subjected to spraying with a plurality of spraying textures, the texture of a patch closest to (having a minimum depth value) the point may be used. For example, in the case of A in FIG. 14, a point 191 is to be subjected to spraying with a texture “6” of a spraying patch on a plane of projection 192 and a texture “7” of a spraying patch on a plane of projection 193. In this case, the plane of projection 193 is closer to the point 191 than the plane of projection 192, so that the texture “7” of the spraying patch on the plane of projection 193 is sprayed to the point 191.

The plurality of textures may be synthesized (blended). Specifically, if a plurality of attributes correspond to a single geometry (single point) in a three-dimensional space, an attribute derived by using the plurality of attributes may be added to the single geometry. The synthesis (blending) may be performed by any method. For example, the synthesis may be an average of multiple colors or a weighted average corresponding to a distance from the plane of projection.

A texture (color) in the projection direction close to the normal line of the point may be selected. Specifically, if a plurality of attributes correspond to a single geometry (single point) in a three-dimensional space, one of the attributes may be added to the geometry. For example, in B of FIG. 14, it is assumed that a projection direction 206 from a point 202 of an object 201 to a plane of projection 204 is closer to a normal line 207 of the point 202 than a projection direction 205 to a plane of projection 203. In this case, the texture of a spraying patch of the plane of projection 204 is selected as a texture of the point 202 (sprayed to the point 202).

The foregoing selection is merely exemplary, and a texture (color) may be determined by other methods. Moreover, information about a method of determining a texture (color) may be signaled (coded and transmitted to the decoding side), and a texture (color) may be determined by a method based on the signaled information.

<Transmission Information>

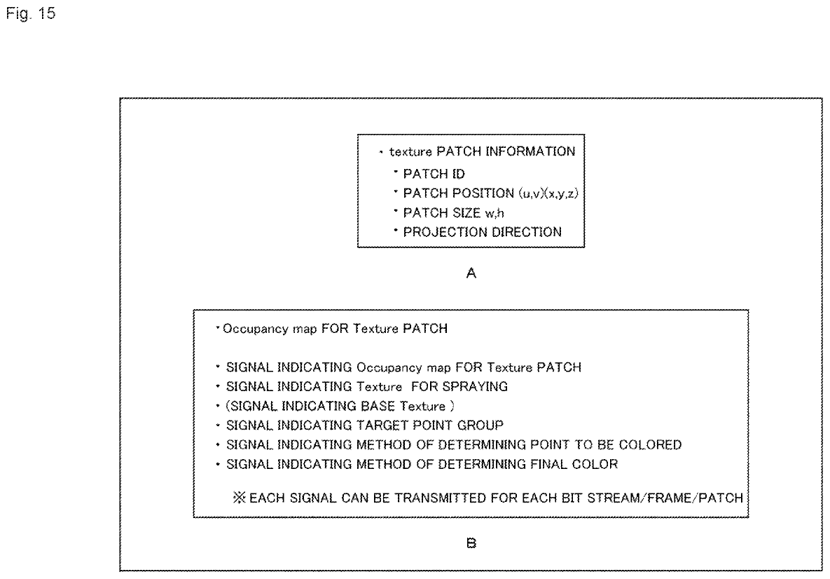

Any information may be transmitted from the coding side and the decoding side. For example, information about a spraying texture may be signaled (coded and transmitted to the decoding side). For example, as indicated in A of FIG. 15, texture patch information, which is information about the patch of a spraying texture, may be transmitted. Any contents are included in the texture patch information. For example, as indicated in A of FIG. 15, the contents may include the ID of a spraying patch, the position of the spraying patch, the size of the spraying patch, and the projection direction of the spraying patch.

For example, information may be signaled as indicated in B of FIG. 15. For example, an occupancy map for a spraying patch may be signaled. Moreover, information indicating that the occupancy map is an occupancy map for a spraying patch may be signaled. Furthermore, identification information indicating that a texture is a spraying texture (a texture used for spraying) may be signaled. Alternatively, identification information indicating that a texture is a base texture (a texture not used for spraying) may be signaled.

In addition, information about the control of spraying may be signaled. Specifically spraying may be performed on the basis of the signaled information on the decoding side, and an attribute may be added to 3D data on a geometry in a three-dimensional space. For example, information about a target of spraying may be signaled. Moreover, information about a method of determining a texture addition point may be signaled. Furthermore, information about a method of determining a texture to be added may be signaled.

As a matter of course, any information may be signaled without being limited to these examples. The information may be signaled in any data units including a bit stream, a frame, and a patch. In other words, information to be signaled may be updated in any data units.

### Other Examples

A plurality of spraying textures may be provided for spraying the same area. For example, a plurality of spraying textures with different resolutions may be generated, and a texture with a high resolution may be used as an enhancement layer. Furthermore, the point of a point in an occlusion area may be kept by generating a plurality of spraying textures. Thus, lossless compression can be supported.

A spraying texture may be configured with any components. For example, a spraying texture may be configured with RGB or only luminance (Y).

The value of a spraying texture may be an absolute value or a difference value from a base texture. A spraying texture with an absolute value can be used for, for example, coloring on an uncolored point or replacement of a base color. A spraying texture with a difference value can be used for addition with a base color.

A spraying texture is projected in any direction. A direction may be selected from a predetermined number of options or any direction may be set.

In the foregoing description, a texture (color) is used as an example of an attribute. Any attribute may be used for spraying without being limited to a texture (color).

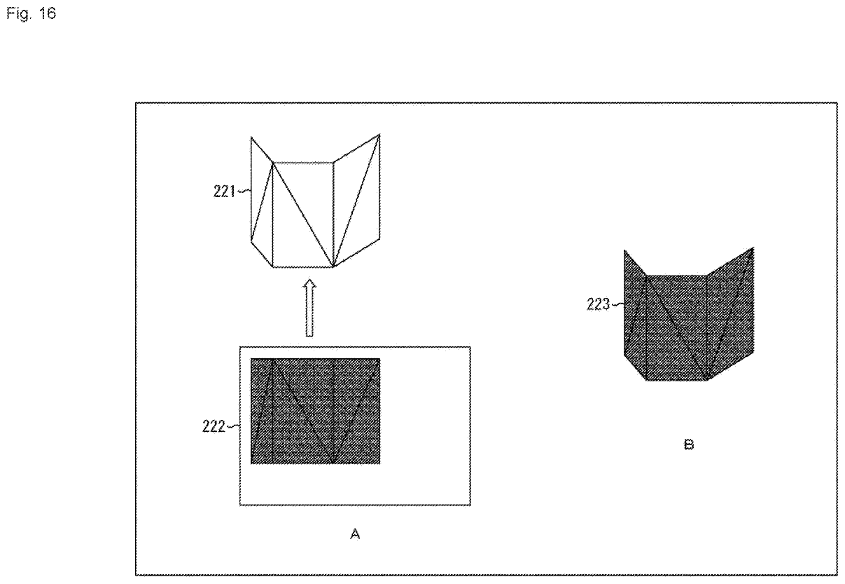

In the foregoing description, a point cloud is used as 3D data to be subjected to spraying. Any 3D data may be used for spraying without being limited to a point cloud. For example, as illustrated in FIG. 16, a mesh may be used. For example, as illustrated in A of FIG. 16, a spraying texture 222 may be sprayed to mesh data 221 (only position information on each face). By performing spraying, mesh data 223 in which the texture is added to each face of the mesh data 221 can be generated as illustrated in B of FIG. 16.

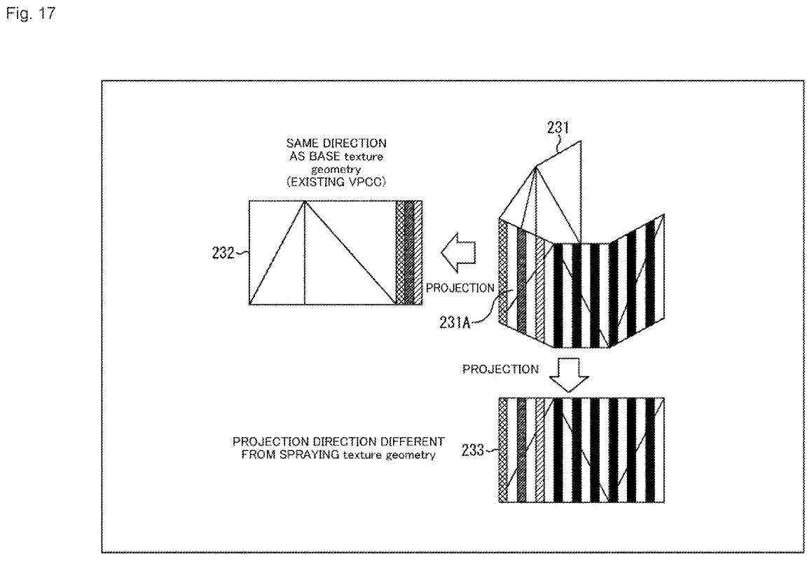

For example, as indicated in FIG. 17, the texture on each face of the mesh data 231 is projected in the same projection direction as a geometry to generate a patch 232 of a base texture and is projected in a projection direction different from the geometry to generate a spraying texture 233.

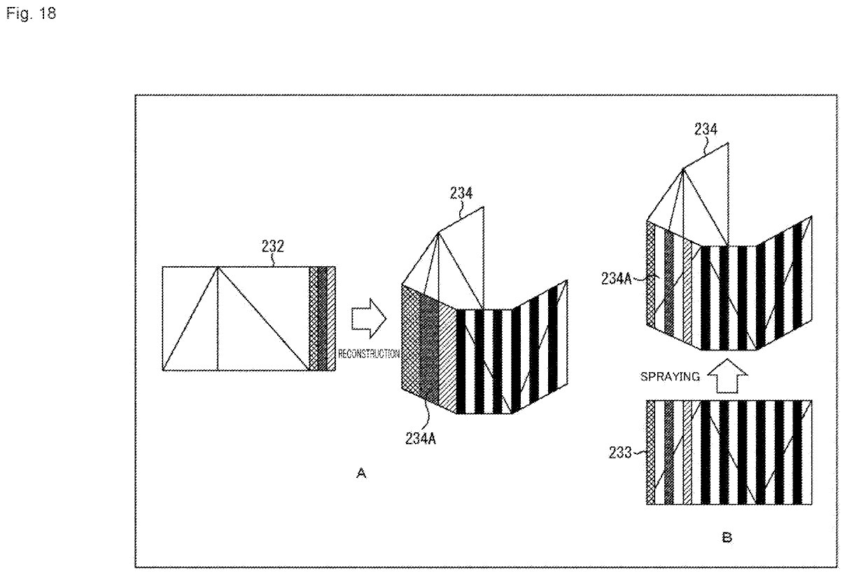

For example, in the case of the patch 232 of a base texture, it is assumed that the direction of projection to a face 231A forms an undesirable angle and causes a deteriorated texture. As indicated in A of FIG. 18, if mesh data 234 is reconstructed using the patch 232, the texture of a face 234A may be extended and deteriorated. In this case, for example, as illustrated in B of FIG. 18, the texture of the face 234A can be overwritten by performing spraying using a spraying texture projected in a different direction from the geometry. This can suppress a deterioration of the texture. As described above, the projection direction of the spraying texture is independent of the projection direction of the geometry. Thus, even if a texture deteriorates in the projection direction of a geometry, a spraying texture projected in a different direction can be generated. This can suppress a deterioration of the texture and a loss of the subjective image quality of a display image.

### 3. First Embodiment

<Coding Device>

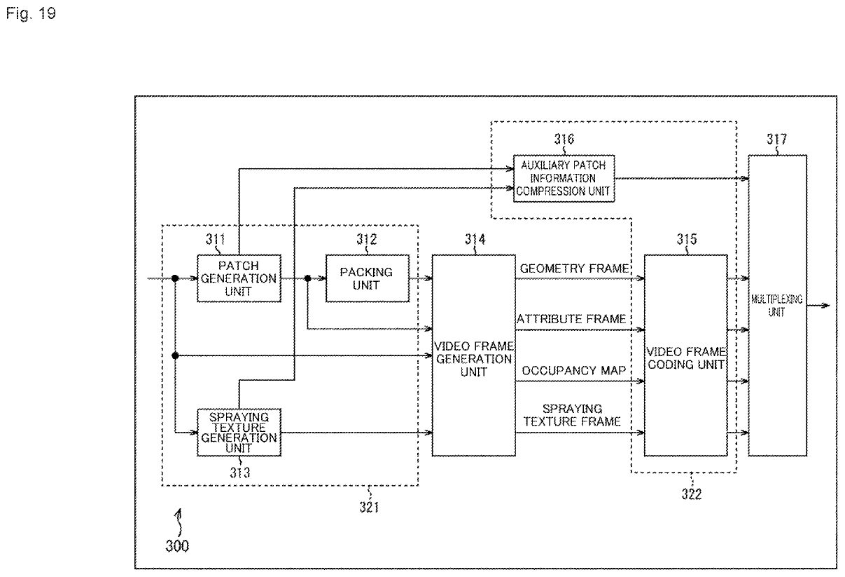

FIG. 19 is a block diagram illustrating an example of the configuration of a coding device according to an embodiment of an image processing device to which the present technique is applied. A coding device 300 illustrated in FIG. 19 is a device that performs coding according to a coding method for a two-dimensional image by applying a video-based approach and using point cloud data as a video frame. The coding device 300 can generate a spraying texture and perform coding by applying the present technique described in <2. Spraying>.

FIG. 19 illustrates principal components such as processing units and data flows, and all of the components are not illustrated in FIG. 19. Specifically, the coding device 300 may include processing units that are not illustrated as blocks in FIG. 19 and processing and data flows that are not illustrated as arrows or the like in FIG. 19.

As illustrated in FIG. 19, the coding device 300 includes a patch generation unit 311, a packing unit 312, a spraying texture generation unit 313, a video frame generation unit 314, a video frame coding unit 315, an auxiliary patch information compression unit 316, and a multiplexing unit 317. The patch generation unit 311, the packing unit 312, and spraying texture generation unit 313 may be regarded as a projection image generation unit 321 in the present disclosure. The video frame coding unit 315 and the auxiliary patch information compression unit 316 may be regarded as a coding unit 322 in the present disclosure.

The patch generation unit 311 generates a patch of a geometry and a patch of an attribute by acquiring a point cloud inputted to the coding device 300, decomposing the acquired point cloud into small areas, and projecting each of the small areas onto a plane of projection. The attribute is a base attribute. Abase patch is generated by the processing. The patch of the attribute is a patch having the same shape and size as the patch of the geometry. The attribute and the geometry at the same position in a projection image correspond to the patches. The generation of the patch of the attribute may be omitted. In this case, the attribute is provided only as a spraying texture.

The patch generation unit 311 supplies these patches to the packing unit 312 and the video frame generation unit 314.

The patch generation unit 311 supplies information about the generated patches (for example, a patch ID and position information) to the auxiliary patch information compression unit 316.

The packing unit 312 acquires the patches of the geometry and the attribute, the patches being supplied from the patch generation unit 311. The packing unit 312 then packs the acquired patches of the geometry and the attribute into a video frame to generate an occupancy map.

The packing unit 312 supplies the generated occupancy map to the video frame generation unit 314.

The spraying texture generation unit 313 acquires a point cloud to be inputted to the coding device 300 and projects the attribute (texture) of the acquired point cloud to the plane of projection to generate a spraying texture. For example, the spraying texture generation unit 313 divides the point cloud into small areas and projects each of the small areas to the plane of projection to generate the spraying texture.

As described in <2. Spraying>, the spraying texture generation unit 313 sets the small areas of the texture and the projection direction independently of the small areas of the base patch generated by the patch generation unit 311 and the projection direction. Specifically, the spraying texture generation unit 313 generates a spraying attribute projection image, which is used for spraying for adding an attribute to a geometry in the reconstruction of 3D data in a three-dimensional space, by projecting an attribute of 3D data representing an object in a three-dimensional shape onto a two-dimensional plane independently of the projection of a geometry of the 3D data onto the two-dimensional plane. Therefore, as described in <2. Spraying>, the coding device 300 can suppress an increase in the amount of coding. At this point, the spraying texture generation unit 313 can properly apply the methods described in <2. Spraying>. In other words, the coding device 300 can obtain other effects described in <2. Spraying>.

The spraying texture generation unit 313 may generate an occupancy map for the spraying texture. In other words, the spraying texture generation unit 313 may generate an occupancy map corresponding to a partial area of the projection of the attribute. The spraying texture generation unit 313 supplies the generated spraying texture (a patch for spraying) to the video frame generation unit 314. If an occupancy map for the spraying texture is generated, the spraying texture generation unit 313 also supplies the occupancy map to the video frame generation unit 314. Moreover, the spraying texture generation unit 313 spraying texture information, which is information about the generated spraying texture, to the auxiliary patch information compression unit 316. Any contents are included in the spraying texture information. For example, information described with reference to FIG. 15 may be included.

The video frame generation unit 314 acquires the patches supplied from the patch generation unit 311, the occupancy map supplied from the packing unit 312, and the spraying texture supplied from the spraying texture generation unit 313. The video frame generation unit 314 further acquires the point cloud inputted to the coding device 300.

The video frame generation unit 314 generates a video frame on the basis of the information. For example, the video frame generation unit 314 generates a geometry frame, which is a video frame including the patch of the geometry, on the basis of the occupancy map supplied from the packing unit 312 and supplies the geometry frame to the video frame coding unit 315. The video frame generation unit 314 further generates an attribute frame, which is a video frame including the patch of a base attribute, on the basis of the occupancy map and supplies the attribute frame to the video frame coding unit 315. If the patch of the base attribute is not generated, the generation of the attribute frame is omitted. The video frame generation unit 314 also supplies the occupancy map supplied from the packing unit 312, as a video frame to the video frame coding unit 315.

The video frame generation unit 314 further generates a spraying texture frame, which is a video frame including the spraying texture supplied from the spraying texture generation unit 313, and supplies the spraying texture frame to the video frame coding unit 315. If the spraying texture generation unit 313 generates the occupancy map for the spraying texture, the video frame generation unit 314 also supplies the occupancy map as a video frame to the video frame coding unit 315.

The video frame coding unit 315 codes the video frames supplied from the video frame generation unit 314 and generates coded data. For example, the video frame coding unit 315 codes the geometry frame and generates geometry coded data. The video frame coding unit 315 also codes the attribute frame and generates attribute coded data. If the patch of the base attribute is not generated, the attribute frame is not generated. Thus, the coding of the attribute frame is omitted. Furthermore, the video frame coding unit 315 codes the occupancy map and generates occupancy map coded data. Moreover, the video frame coding unit 315 codes the spraying texture frame and generates spraying texture coded data. If the spraying texture generation unit 313 generates the occupancy map for the spraying texture, the video frame coding unit 315 also codes the occupancy map.

The video frame coding unit 315 supplies the coded data to the multiplexing unit 317.

The auxiliary patch information compression unit 316 acquires various kinds of information supplied from the patch generation unit 311 and the spraying texture generation unit 313. The auxiliary patch information compression unit 316 then generates auxiliary patch information including the information and codes (compresses) the generated auxiliary patch information. In other words, the auxiliary patch information compression unit 316 codes (compresses) the spraying texture information. The information is coded by any method. For example, a coding method for a two-dimensional image may be applied or run-length coding or the like may be applied. The auxiliary patch information compression unit 316 supplies the obtained auxiliary patch information coded data to the multiplexing unit 317.

The multiplexing unit 317 acquires various kinds of coded data supplied from the video frame coding unit 315. Moreover, the multiplexing unit 317 acquires the auxiliary patch information coded data supplied from the auxiliary patch information compression unit 316. The multiplexing unit 317 multiplexes the acquired coded data to generate a bit stream. The multiplexing unit 317 outputs the generated bit stream to the outside of the coding device 300.

These processing units (the patch generation unit 311 to the multiplexing unit 317) have any configurations. For example, each of the processing units may be configured with a logical circuit that implements the aforementioned processing. Each of the processing units may have, for example, a central processing unit (CPU), a read only memory (ROM), and a random access memory (RAM) or the like, and the aforementioned processing may be implemented by executing a program using the CPU and memories. It goes without saying that each processing unit may have both the aforementioned configurations, a part of the aforementioned processing may be implemented by a logic circuit, and the other part of the processing may be implemented by executing a program. The processing units may have independent configurations, for example, some of the processing units may implement a part of the aforementioned processing by using a logic circuit, other processing units may implement the aforementioned processing by executing a program, and some other processing units may implement the aforementioned processing by both of a logic circuit and the execution of a program.

<Flow of Coding>

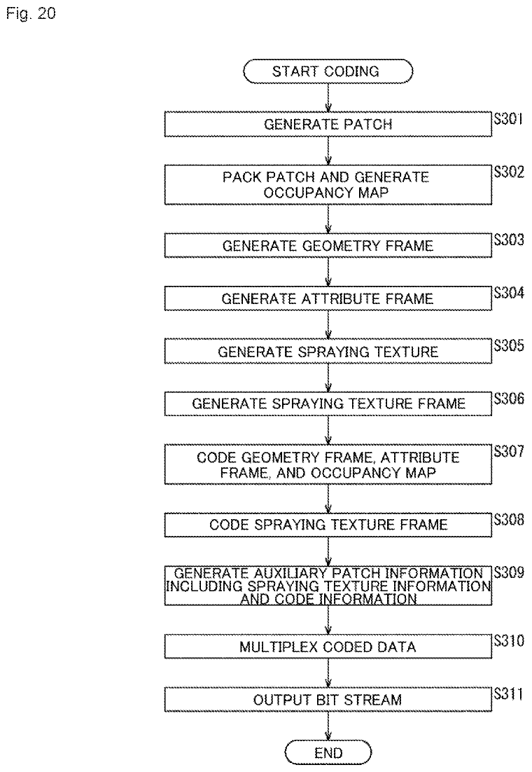

An example of a flow of coding performed by the coding device 300 will be described below with reference to the flowchart of FIG. 20.

When coding is started, in step S301, the patch generation unit 311 of the coding device 300 decomposes the point cloud into small areas and generates the patch of the geometry or attribute by projecting each of the small areas to a two-dimensional plane.

In step S302, the packing unit 312 packs the patch generated in step S301 into a video frame and generates an occupancy map.

In step S303, the video frame generation unit 314 generates a geometry frame by using the occupancy map generated in step S302.

In step S304, the video frame generation unit 314 generates an attribute frame by using the occupancy map generated in step S302.

In step S305, the spraying texture generation unit 313 generates a spraying texture independently of the patch of the geometry or attribute. Moreover, the spraying texture generation unit 313 generates spraying texture information about the spraying texture.

In step S306, the video frame generation unit 314 generates a spraying texture frame by using the spraying texture generated in step S305.

In step S307, the video frame coding unit 315 codes the geometry frame, the attribute frame, and the occupancy map.

In step S308, the video frame coding unit 315 codes the spraying texture frame.

In step S309, the auxiliary patch information compression unit 316 generates auxiliary patch information including spraying texture information and codes the information.

In step S310, the multiplexing unit 317 multiplexes the geometry coded data, the attribute coded data, and the occupancy map that are obtained by the processing of step S307, the spraying texture coded data that is obtained by the processing of step S308, and the auxiliary patch information coded data that is obtained by the processing of step S309 to generate a bit stream.

In step S311, the multiplexing unit 317 outputs the bit stream generated by the processing of step S310 to the outside of the coding device 300. At the completion of the processing of step S311, coding terminates.

By performing the foregoing processing, the coding device 300 can generate a spraying texture independently of the patch of the geometry as described in <2. Spraying>. Therefore, as described in <2. Spraying>, the coding device 300 can suppress an increase in the amount of coding. At this point, the methods described in <2. Spraying> can be properly applied. In other words, the coding device 300 can also obtain other effects described in <2. Spraying>.

### 4. Second Embodiment

<Decoding Device>

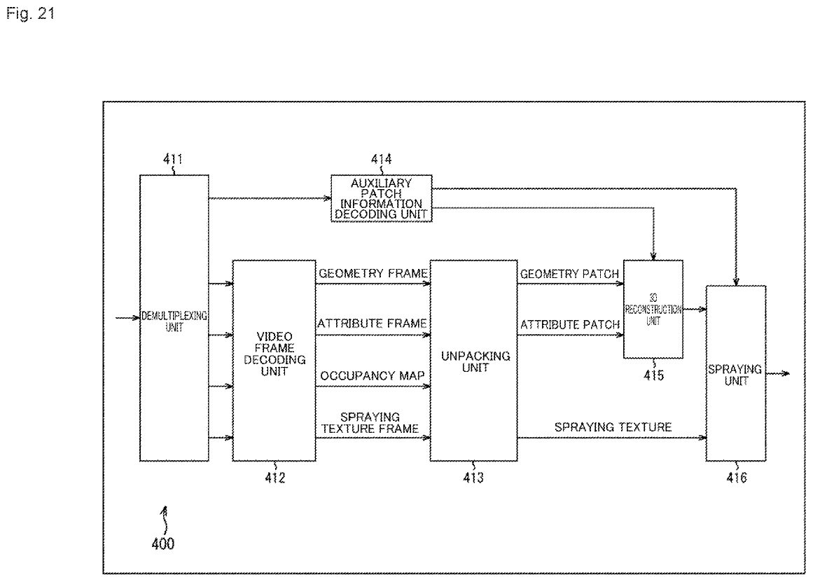

FIG. 21 is a block diagram illustrating an example of a configuration of a decoding device according to an aspect of an image processing device to which the present technique is applied. A decoding device 400 illustrated in FIG. 21 is a device that applies to a video-based approach, decodes, according to a decoding method for a two-dimensional image, coded data obtained by coding point cloud data as a video frame according to a coding method for a two-dimensional image, and generates (reconstructs) a point cloud. At this point, the present technique described in <2. Spraying> is applied to the decoding device 400, so that spraying for reconstructing 3D data can be performed by spraying a spraying texture, which is generated independently of a geometry, to the geometry in a three-dimensional space on the basis of the position and orientation of a projection image.

FIG. 21 illustrates principal components such as processing units and data flows, and not all of the components are illustrated in FIG. 21. Specifically, the decoding device 400 may include processing units that are not illustrated as blocks in FIG. 21 and processing and data flows that are not illustrated as arrows or the like in FIG. 21.

As illustrated in FIG. 21, the decoding device 400 includes a demultiplexing unit 411, a video frame decoding unit 412, an unpacking unit 413, an auxiliary patch information decoding unit 414, a 3D reconstruction unit 415, and a spraying unit 416.

The demultiplexing unit 411 acquires a bit stream inputted to the decoding device 400. This bit stream is generated by, for example, coding the point cloud data in the coding device 300.

The demultiplexing unit 411 demultiplexes the bit stream and generates coded data that is included in the bit stream. In other words, the demultiplexing unit 411 extracts coded data from the bit stream by demultiplexing. For example, the demultiplexing unit 411 generates geometry coded data, attribute coded data, occupancy map coded data, spraying texture coded data, and auxiliary patch information coded data. If the bit stream does not include attribute coded data, the generation of the attribute coded data is omitted. If coded data on an occupancy map for a spraying texture is included, the demultiplexing unit 411 also generates the coded data.

The demultiplexing unit 411 supplies the geometry coded data, the occupancy map coded data, and the spraying texture coded data to the video frame decoding unit 412 from among the generated coded data. If attribute coded data or coded data on an occupancy map for a spraying texture is generated, the demultiplexing unit 411 also supplies the data to the video frame decoding unit 412. Moreover, the demultiplexing unit 411 supplies the auxiliary patch information coded data to the auxiliary patch information decoding unit 414.

The video frame decoding unit 412 acquires the geometry coded data, the occupancy map coded data, and the spraying texture coded data that are supplied from the demultiplexing unit 411. If attribute coded data or coded data on an occupancy map for a spraying texture is supplied from the demultiplexing unit 411, the video frame decoding unit 412 also acquires the data.

Furthermore, the video frame decoding unit 412 decodes the acquired geometry coded data to generate a geometry frame. Specifically, the video frame decoding unit 412 decodes coded data on a geometry frame image including a geometry projection image that is projected on a two-dimensional plane representing a geometry of 3D data representing an object in a three-dimensional shape. Moreover, the video frame decoding unit 412 decodes the acquired attribute coded data to generate an attribute frame. If the attribute coded data is not acquired, the decoding of the attribute coded data is omitted. Furthermore, the video frame decoding unit 412 decodes the acquired occupancy map coded data to generate an occupancy map.

Moreover, the video frame decoding unit 412 decodes the acquired spraying texture coded data to generate a spraying texture frame. Specifically, the video frame decoding unit 412 decodes coded data on an attribute frame image including an attribute projection image representing an attribute of 3D data projected on a two-dimensional plane independent of the two-dimensional plane of a geometry projection image of 3D data representing an object in a three-dimensional shape. If coded data on an occupancy map for a spraying texture is acquired, the video frame decoding unit 412 decodes the coded data to generate the occupancy map for the spraying texture.

The video frame decoding unit 412 supplies the generated geometry frame, occupancy map, and spraying texture frame to the unpacking unit 413. If an attribute frame or an occupancy map for a spraying texture is generated, the video frame decoding unit 412 also supplies the frame or the map to the unpacking unit 413.

The unpacking unit 413 acquires the geometry frame, the occupancy map, and the spraying texture that are supplied from the video frame decoding unit 412. If an attribute frame or an occupancy map for a spraying texture is supplied from the video frame decoding unit 412, the unpacking unit 413 also acquires the frame or the map. The unpacking unit 413 unpacks the geometry frame on the basis of the acquired occupancy map to generate a geometry patch. Furthermore, the unpacking unit 413 unpacks the attribute frame on the basis of the acquired occupancy map to generate an attribute patch. If the attribute frame is not acquired, the generation of the attribute patch is omitted. The unpacking unit 413 supplies the generated geometry patch to the 3D reconstruction unit 415. If an attribute patch is generated, the unpacking unit 413 supplies the attribute patch to the 3D reconstruction unit 415.

Furthermore, the unpacking unit 413 unpacks the spraying texture frame independently of the geometry and the attribute and generates a spraying texture. If an occupancy map for a spraying texture is acquired, the unpacking unit 413 unpacks the spraying texture frame on the basis of the occupancy map. The unpacking unit 413 supplies the generated spraying texture to the spraying unit 416.

The auxiliary patch information decoding unit 414 acquires the auxiliary patch information coded data supplied from the demultiplexing unit 411. The auxiliary patch information decoding unit 414 decodes the acquired auxiliary patch information coded data to generate auxiliary patch information. The auxiliary patch information decoding unit 414 supplies spraying texture information included in the generated auxiliary patch information to the spraying unit 416 and supplies other information to the 3D reconstruction unit 415.

The 3D reconstruction unit 415 acquires the geometry patch supplied from the unpacking unit 413. If an attribute patch is supplied from the unpacking unit 413, the 3D reconstruction unit 415 also acquires the attribute patch. Moreover, the 3D reconstruction unit 415 acquires the auxiliary patch information supplied from the auxiliary patch information decoding unit 414. The 3D reconstruction unit 415 generates (reconstructs) a point cloud by using the information. In other words, the 3D reconstruction unit 415 generates 3D data (including a point cloud) by arranging at least a geometry in a three-dimensional space. In the presence of a base attribute patch, the 3D reconstruction unit 415 reconstructs 3D data with the attribute associated with the geometry. In the absence of a base attribute patch, the 3D reconstruction unit 415 reconstructs 3D data including only a geometry (3D data in which an attribute is not added).

The 3D reconstruction unit 415 supplies the reconstructed 3D data to the spraying unit 416.

The spraying unit 416 acquires the spraying texture supplied from the unpacking unit 413. Moreover, the spraying unit 416 acquires the spraying texture information supplied from the auxiliary patch information decoding unit 414. The spraying unit 416 further acquires the 3D data supplied from the 3D reconstruction unit 415.

The spraying unit 416 performs spraying by using the acquired information as described in <2. Spraying> and adds the spraying texture to the 3D data (geometry) in a three-dimensional space. Specifically the spraying unit 416 performs spraying such that an attribute obtained from the attribute frame information is added to 3D data on a geometry in a three-dimensional space on the basis of the position and orientation of the attribute projection image. The spraying unit 416 outputs the 3D data with the added spraying texture to the outside of the decoding device 400. For example, the 3D data is rendered to be displayed on a display unit, is recorded in a recording medium, or is supplied to other devices through communications.

As described above, the spraying unit 416 performs spraying as described in <2. Spraying>, so that the decoding device 400 can suppress an increase in the amount of coding. At this point, the spraying unit 416 can properly apply the methods described in <2. Spraying>. In other words, the decoding device 400 can also obtain other effects described in <2. Spraying>.

These processing units (the demultiplexing unit 411 to the spraying unit 416) have any configurations. For example, each of the processing unit may be configured with a logic circuit for implementing the aforementioned processing. Each of the processing units may include, for example, a CPU, a ROM, and a RAM or the like and may implement the foregoing processing by executing a program using the CPU, the ROM, and the RAM or the like. It goes without saying that each of the processing units may have both of the aforementioned configurations, a part of the processing may be implemented by a logic circuit, and the other part of the processing may be implemented by executing a program. The processing units may have independent configurations, for example, some of the processing units may implement a part of the aforementioned processing by using a logic circuit, other processing units may implement the aforementioned processing by executing a program, and other processing units may implement the aforementioned processing by both of a logic circuit and executing a program.

<Flow of Decoding>

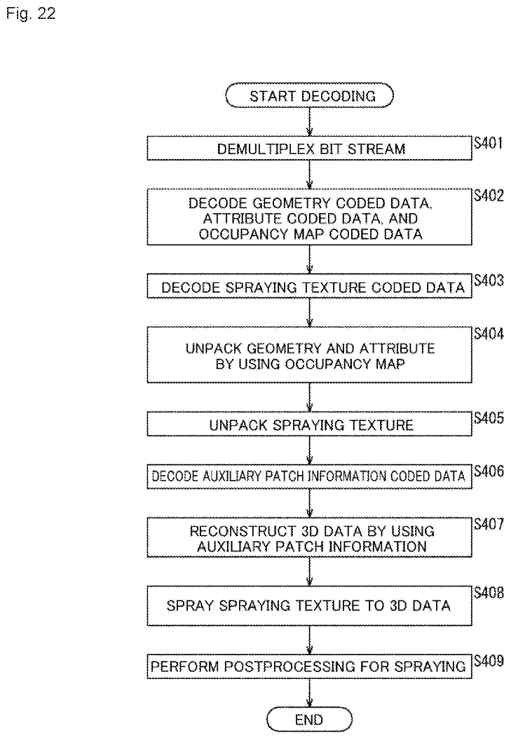

An example of a flow of decoding performed by the decoding device 400 will be described below with reference to the flowchart of FIG. 22.

At the start of decoding, in step S401, the demultiplexing unit 411 of the decoding device 400 demultiplexes a bit stream to generate geometry coded data, attribute coded data, occupancy map coded data, spraying texture coded data, and auxiliary patch information coded data.

In step S402, the video frame decoding unit 412 decodes the geometry coded data, the attribute coded data, and the occupancy map coded data that are obtained in step S401 and generates a geometry frame, an attribute frame, and an occupancy map.

In step S403, the video frame decoding unit 412 decodes the spraying texture coded data obtained in step S401 and generates a spraying texture frame.

In step S404, the unpacking unit 413 unpacks the geometry frame and the attribute frame by using the occupancy map.

In step S405, the unpacking unit 413 unpacks the spraying texture frame.

In step S406, the auxiliary patch information decoding unit 414 decodes the auxiliary patch information coded data obtained in step S401 and generates auxiliary patch information.

In step S407, the 3D reconstruction unit 415 reconstructs 3D data by using the auxiliary patch information obtained in step S406.

In step S408, the spraying unit 416 performs spraying as described in <2. Spraying> and adds the spraying texture obtained in step S405 to the 3D data obtained in step S407.

In step S409, the spraying unit 416 further performs the postprocessing of spraying. For example, the spraying unit 416 performs, as postprocessing, processing for a point uncolored by spraying or processing for a point to be sprayed with multiple textures. In other words, the spraying unit 416 performs spraying by properly applying the methods described in <2. Spraying>.

At the completion of the processing of step S409, decoding terminates.

By performing the foregoing processing, the decoding device 400 can perform spraying as described in <2. Spraying>. Accordingly, the decoding device 400 can suppress an increase in the amount of coding. At this point, the decoding device 400 can properly apply the methods described in <2. Spraying> and thus obtain other effects described in <2. Spraying>.

<5. Multi-Attribute Case>

<Multi-Attribute>

In NPL 5, multi-attribute is disclosed as a method of providing a plurality of attributes for a single geometry (single point) in a video-based approach. By associating a plurality of attributes with a single geometry (single point), for example, a more appropriate attribute can be selected at the time of rendering or a more appropriate attribute can be generated by using the plurality of attributes, thereby suppressing a loss of the subjective image quality of a display image.

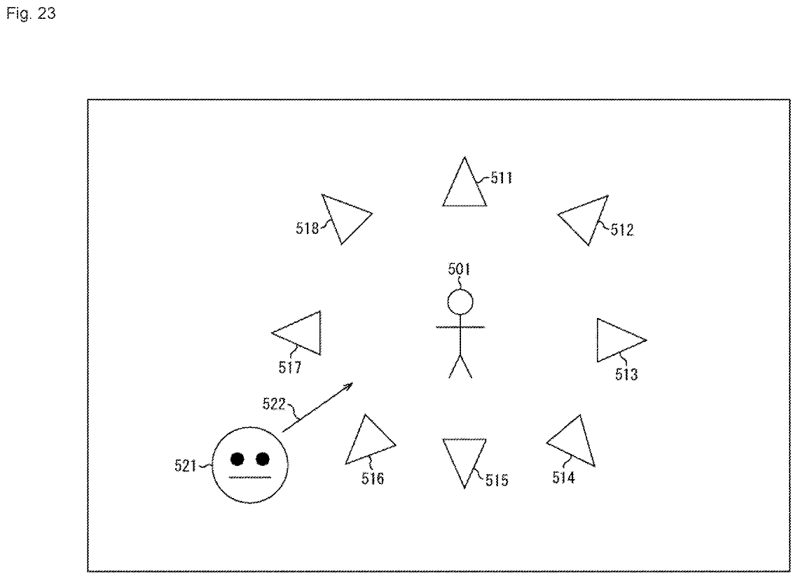

For example, as illustrated in FIG. 23, it is assumed that an object 501 is imaged by a plurality of cameras (cameras 511 to 518) surrounding the object 501 and the attributes of the point cloud of the object 501 are generated by using the textures of the object 501, the textures being obtained from captured images.

A single geometry is generated for the point cloud of the object 501 because the geometry is point information at each point. The eight cameras (cameras 511 to 518) are provided for the geometry and thus eight images are captured. The textures of the object 501 (e.g., the pattern, color, brightness, and feel of the surface of the object 501) are extracted as independent attributes from the captured images, so that eight attributes are generated for the single geometry.

As illustrated in FIG. 23, the positions and orientations of the eight camaras are different from one another. Generally, (the texture of) the object 501 may be viewed differently depending upon the position and direction of the viewpoint. Therefore, the textures of the attributes may be different from one another.

By associating textures obtained from a plurality of viewpoints with a single geometry (single point), textures can be selected with viewpoints at closer positions in closer directions or more appropriate textures can be generated by using the plurality of textures at the time of rendering, thereby suppressing a loss of the subjective image quality of a display image.

For example, by selecting a texture obtained by the camera that captures an image in a direction close to the direction of the line of sight of the user 521 (arrow 522) from a location near the position of the viewpoint of a user 521, a deterioration of the texture can be suppressed and a loss of the subjective image quality of display image can be suppressed.

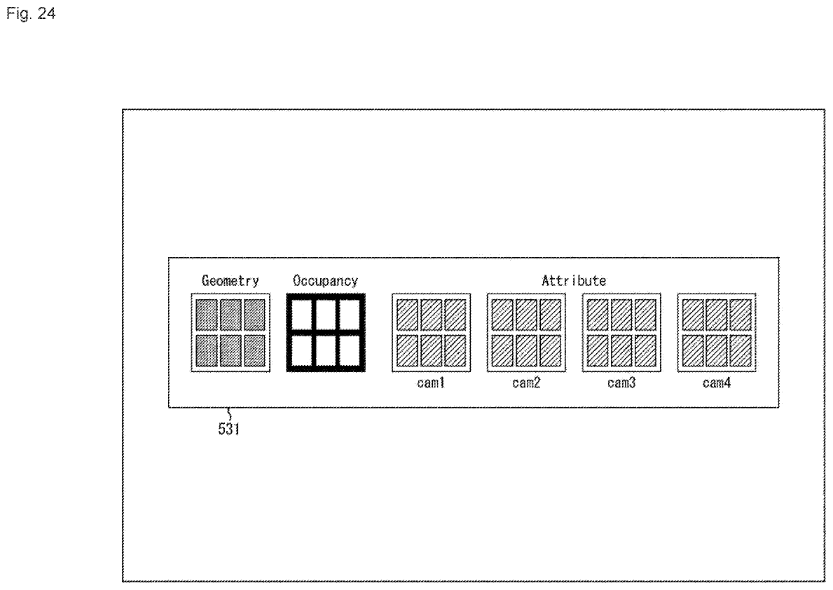

In the case of the video-based approach of multi attribute, as illustrated in FIG. 24, a bit stream includes data and an occupancy map of a single geometry (single point) and data on a plurality of corresponding attributes (data on textures generated by images captured by the cameras).

The present technique described in <2. Spraying> is also applicable to the video-based approach of the multi-attribute. Specifically, as described in <2. Spraying>, spraying can be performed in the decoding device such that a spraying texture is added to a geometry disposed in a three-dimensional space. Moreover, in the coding device, the spraying texture used for spraying can be generated and coded independently of the geometry. Accordingly, also in the case of the video-based approach of the multi-attribute, an increase in the amount of coding can be suppressed. At this point, the methods described in <2. Spraying> can be properly applied. Accordingly, also in the case of the video-based approach of the multi-attribute, other effects described in <2. Spraying> can be obtained.

In the case of such multi-attribute, the transmission of a plurality of textures is required in a portion where the textures considerably vary among the cameras. In other words, portions where similar textures are obtained by the cameras are redundant and thus are less significant. In the case of conventional multi-attribute, textures obtained by the cameras are entirely associated with the geometry, so that a large amount of redundant information may be included and the amount of coding may excessively increase.

By applying the present technique described in <2. Spraying>, the spraying texture can be generated independently of the geometry. Thus, for example, only a significant portion (where textures considerably vary among the cameras) can be transmitted as a spraying texture. This can suppress an increase in the amount of coding. Moreover, in coding and decoding, an increase in the number of frames of textures to be processed can be suppressed, thereby suppressing an increase in the amount of coding or decoding and an increase in used memory capacity.

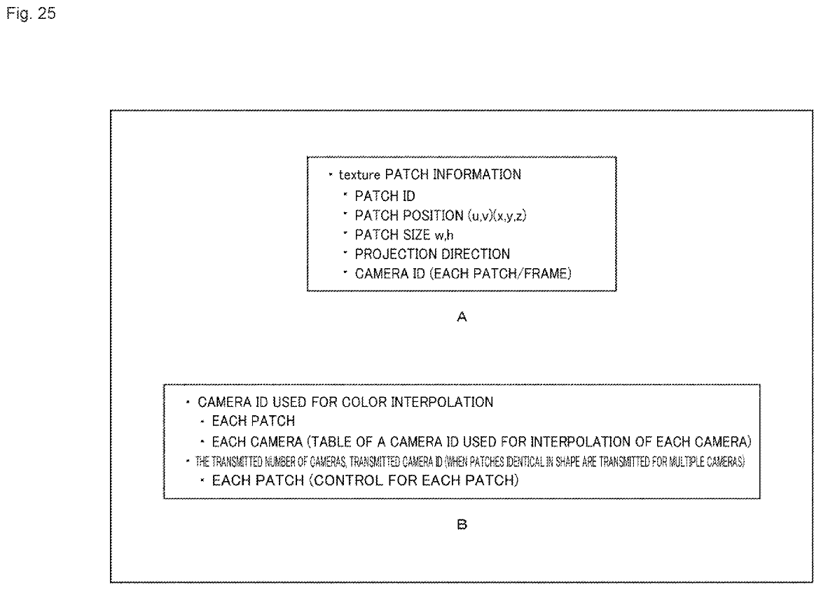

In the case of multi-attribute, as described above, a texture is present in each camera. In this case, information about a texture used for generating a spraying texture may be signaled. For example, as indicated in A of FIG. 25, identification information (camera ID) about a camera corresponding to a texture may be signaled in texture patch information. For example, the camera ID may be signaled for each patch or frame.

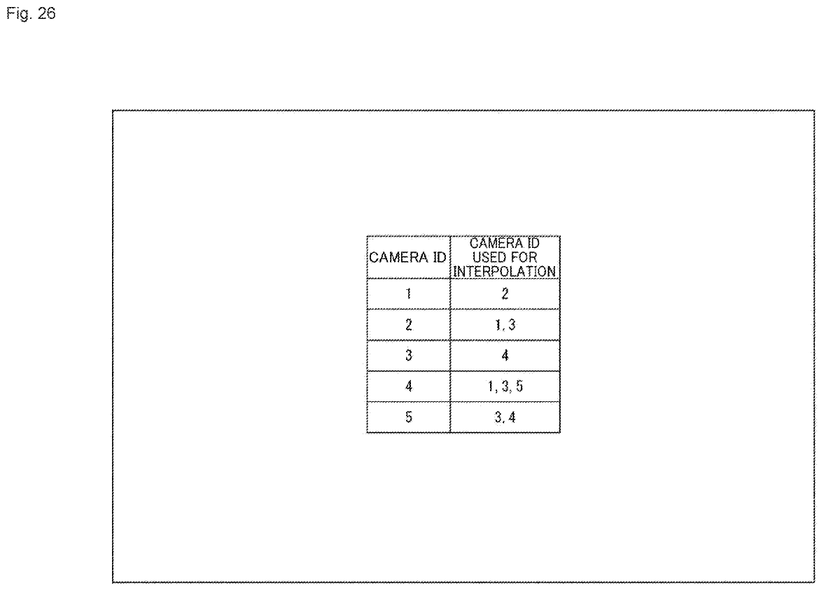

In this case, information indicated in B of FIG. 25 may be also signaled. For example, information about a camera ID used for color interpolation may be signaled. For example, a camera ID may be specified for each patch. Moreover, a camera ID may be specified for each camera. For example, as indicated in FIG. 26, table information about camera IDs used for the interpolation of the cameras may be signaled. Furthermore, the number of textures to be transmitted (that is, the number of cameras) and identification information about the cameras (camera IDs) may be signaled. For example, the information may be signaled for each patch. As a matter of course, the information may be signaled in other data units.

<Determination of Final Color>

For example, if a base color is transmitted, a spraying texture and the base texture may be synthesized (blended) (e.g., a sum, an average, or a weighted average). The base texture may be overwritten by the spraying texture.

Alternatively, a spraying texture may be provided for an extension and whether to use the spraying texture on the decoding side may be selected. For example, when an extend mode is set to an on-state, spraying may be performed while the spraying texture is decoded with the base texture. When the extend mode is set to an off-state, only the base texture may be added to a geometry (that is, the decoding of the spraying texture is omitted).

Moreover, processing on a point uncolored by spraying can be performed as in <2. Spraying>. For example, interpolation (e.g., copying of a value, an average, or a weighted average) may be performed from an adjacent colored point. Interpolation (e.g., copying of a value, an average, or a weighted average) may be performed from a transmitted color of a camera. Moreover, interpolation may be performed from a color of an adjacent camera. Furthermore, interpolation may be performed from a specified camera. For example, a table (a list of camera Is used for interpolation) indicated in FIG. 26 may be transmitted from the coding side to the decoding side. Uncolored points may be provided or omitted.

<Transmission of Texture>

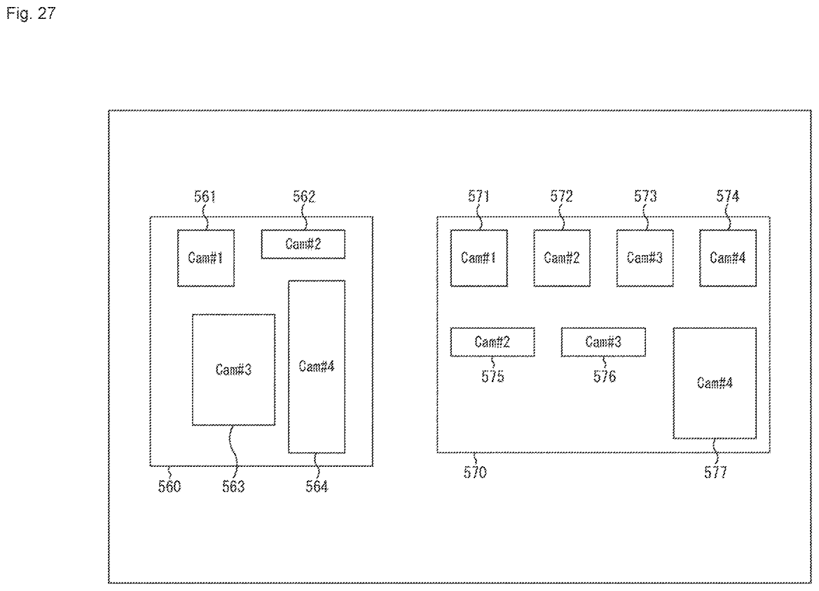

Only the texture of a used camera may be decoded. The textures of cameras may vary in shape. For example, like a texture 561 of Cam #1, a texture 562 of Cam #2, a texture 563 of Cam #3, and a texture 564 of Cam #4, which are included in a texture 560 shown in FIG. 27, the shapes of the textures of the cameras may be different from one another.

Textures having the same shape may be transmitted for a plurality of cameras. For example, a texture 571 of Cam #1, a texture 572 of Cam #2, a texture 573 of Cam #3, and a texture 574 of Cam #4, which are included in a texture 570 shown in FIG. 27, are textures identical in shape. Furthermore, a texture 575 of Cam #2 and a texture 576 of Cam #3, which are included in the texture 570, are textures identical in shape. A texture 574 of Cam #4 included in the texture 570 is a texture having a different shape from the textures of other cameras. In the presence of textures having the same shape, texture patch information or an occupancy map thereof may be shared among the textures.

The transmitted number of cameras and camera IDs may be controlled for each patch. In this case, information about the number of cameras may be transmitted for each patch ID. Alternatively, information about a camera ID may be transmitted for each patch ID.

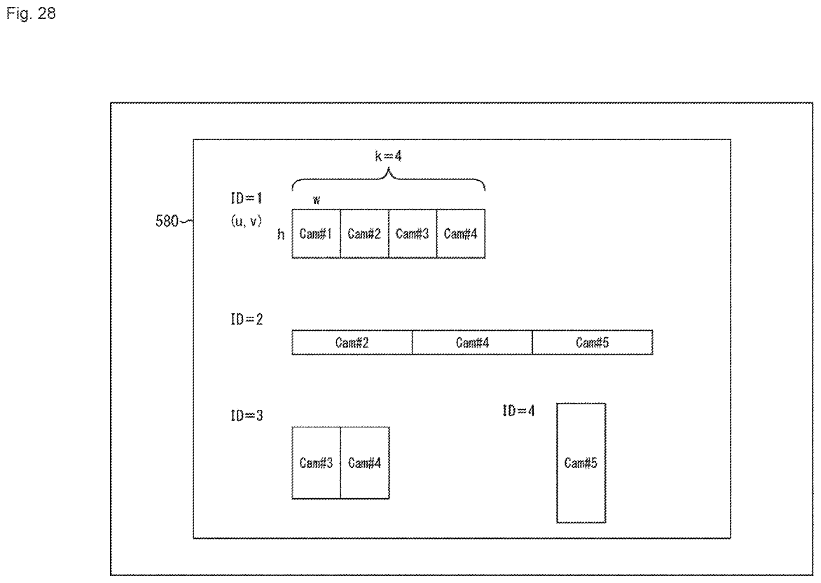

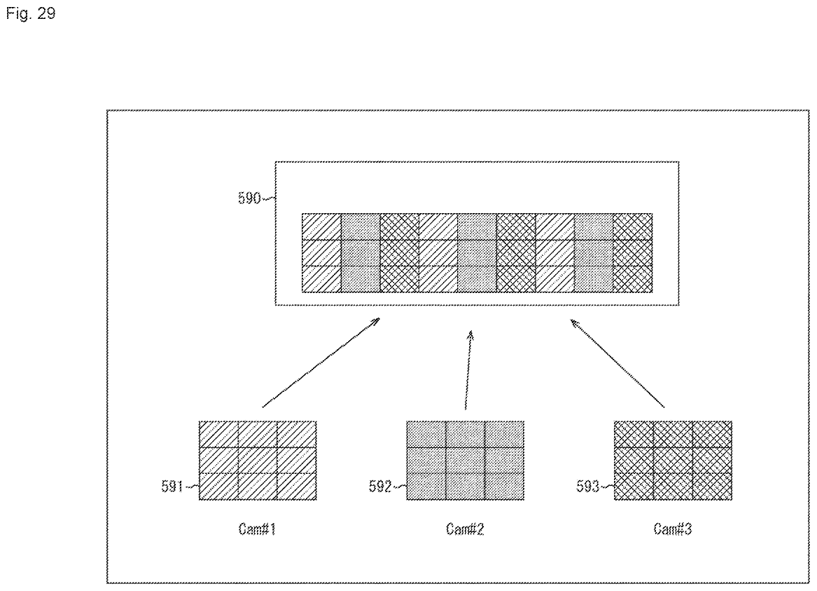

If textures having the same shape are transmitted for a plurality of cameras, for example, textures identical in shape may be arranged as in a texture 580 shown in FIG. 28. Alternatively, like a texture 590 shown in FIG. 29, a texture 591 of Cam #1, a texture 592 of Cam #2, and a texture 593 of Cam #3 may be arranged in a mixed manner.

As a matter of course, the textures of the cameras may be arranged according to any method. The arrangement is not limited to these examples.

<6. Supplement>

<3D Data>

Although cases in which the present technique is applied to coding/decoding of point cloud and meshes have been described above, the present technique is not limited to such examples and can be applied to coding/decoding of 3D data in any standard. That is, any specifications of various processing such as encoding and decoding methods and various types of data such as 3D data or metadata are used as long as these do not contradict with the present technique described above. Some of the above-described processing steps or specifications may be omitted as long as the processing and specifications are inconsistent with the present technique.

<Computer>

The above-described series of processing can be executed by hardware or software. When the series of processing is executed by software, a program that constitutes the software is installed in the computer. Here, the computer includes, for example, a computer built in dedicated hardware and a general-purpose personal computer on which various programs are installed to be able to execute various functions.

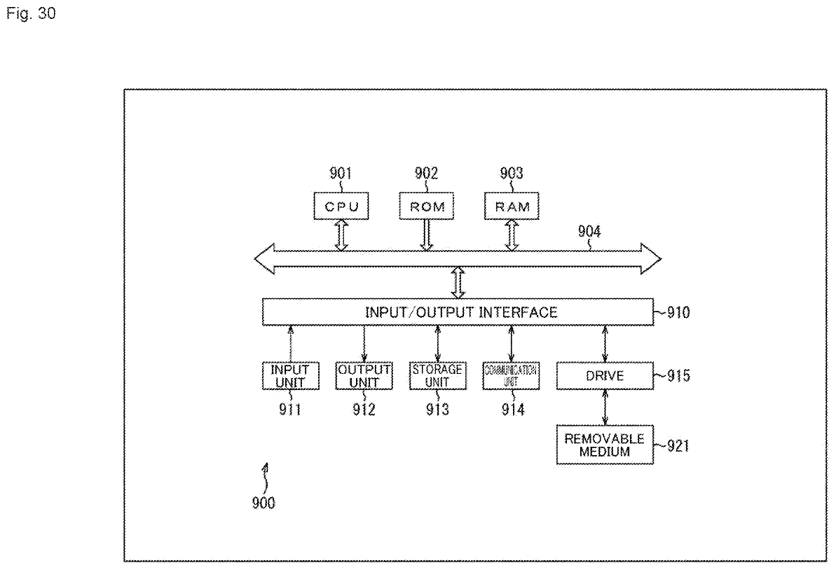

FIG. 30 is a block diagram showing an example of a hardware configuration of a computer that executes the above-described series of processing according to a program.

In a computer 900 illustrated in FIG. 30, a central processing unit (CPU) 901, a read only memory (ROM) 902, and a random access memory (RAM) 903 are connected to one another via a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, or an input terminal. The output unit 912 includes, for example, a display, a speaker, or an output terminal. The storage unit 913 includes, for example, a hard disk, a RAM disk, or a non-volatile memory. The communication unit 914 includes, for example, a network interface. The drive 915 drives a removable medium 921 such as a magnetic disk, an optical disc, a magneto-optical disk, or a semiconductor memory.

In the computer configured as described above, the CPU 901 loads a program stored in the storage unit 913 into the RAM 903 via the input/output interface 910 and the bus 904 and executes the program, so that the series of processing is performed. Furthermore, data or the like necessary for various kinds of processing by the CPU 901 is properly stored in the RAM 903.

The program to be executed by the computer can be recorded and applied in, for example, the removable medium 921 as a package medium or the like. In such a case, the program can be installed in the storage unit 913 via the input/output interface 910 by inserting the removable medium 921 into the drive 915.

This program can also be provided via a wired or wireless transfer medium such as a local area network, the Internet, and digital satellite broadcasting. In such a case, the program can be received by the communication unit 914 and installed in the storage unit 913.

Alternatively, this program can be installed in the ROM 902 or the storage unit 913 in advance.

<Application Target of Present Technique>

The present technique can be applied to any configuration. For example, the present technique can be applied to a variety of electronic devices.

Furthermore, for example, the present technique can be implemented as a part of the configuration of the device, such as a processor (for example, a video processor) as a system large scale integration (LSD or the like, a module (for example, a video module) using a plurality of processors or the like, a unit (for example, a video unit) using a plurality of modules or the like, or a set (for example, a video set) in which other functions are added to the unit.

For example, the present technique can also be applied to a network system configured with a plurality of devices. The present technique may be implemented as, for example, cloud computing for processing shared among a plurality of devices via a network. For example, the present technique may be implemented in a cloud service that provides services regarding images (moving images) to any terminals such as a computer, an audio visual (AV) device, a mobile information processing terminal, and an Internet-of-Things (IoT) device or the like.

In the present specification, a system means a set of constituent elements (devices and modules (parts) or the like) regardless of whether all the constituent elements are located in the same casing. Accordingly, a plurality of devices stored in separate casings and connected via a network and a single device with a plurality of modules stored in a single casing are all systems.

<Fields and Applications to which Present Technique is Applicable>

A system, a device, and a processing unit or the like to which the present technique is applied can be used in any field, for example, transportation, medical care, crime prevention, agriculture, the livestock industry, mining, beauty, factories, home appliances, weather, nature monitoring, and the like. The application of the present technique can also be implemented as desired.

<Others>

Note that “flag” in the present specification is information for identifying a plurality of states and includes not only information used to identify two states of true (1) or false (0) but also information that allows identification of three or more states. Therefore, a value that can be indicated by “flag” may be, for example, a binary value of 1 or 0 or may be ternary or larger. In other words, the number of bits constituting “flag” may be any number, e.g., 1 bit or a plurality of bits. It is also assumed that the identification information (also including a flag) is included in a bit stream or the difference information of identification information with respect to certain reference information is included in a bit stream. Thus, “flag” and “identification information” in the present specification include not only the information but also the difference information with respect to the reference information.

Various kinds of information (such as metadata) related to coded data (bitstream) may be transmitted or recorded in any form as long as the information is associated with coded data. For example, the term “associate” means that when one data is processed, the other may be used (may be associated). In other words, mutually associated items of data may be integrated into one item of data or may be individual items of data. For example, information associated with coded data (image) may be transmitted through a transmission path that is different from that for the coded data (image). For example, the information associated with the coded data (image) may be recorded in a recording medium that is different from that for the coded data (image) (or a different recording area in the same recording medium). “Associate” may correspond to part of data instead of the entire data. For example, an image and information corresponding to the image may be associated with a plurality of frames, one frame, or any unit such as a portion in the frame.

In the present specification, terms such as “synthesize”, “multiplex”, “add”, “integrate”, “include”, “store”, “put in”, “enclose”, and “insert” mean, for example, integration of a plurality of objects into one, for example, integration of coded data and metadata into one piece of data, and mean one method of “associate”.

Embodiments of the present technique are not limited to the above-described embodiments and can be changed in various ways within the scope of the present technique.

For example, a configuration described as one device (or processing unit) may be split into and configured as a plurality of devices (or processing units). Conversely, configurations described above as a plurality of devices (or processing units) may be integrated and configured as one device (or processing unit). It is a matter of course that configurations other than the aforementioned configurations may be added to the configuration of each device (or each processing unit). Moreover, some of configurations of a certain device (or processing unit) may be included in a configuration of another device (or another processing unit) as long as the configurations and operations of the overall system are substantially the same.

For example, the aforementioned program may be executed by any device. In this case, the device only needs to have necessary functions (such as functional blocks) to obtain necessary information.

Furthermore, for example, each step of one flowchart may be performed by one device, or may be shared and performed by a plurality of devices. Moreover, when a plurality of processing steps are included in one step, one device may perform the plurality of processing steps, or the plurality of devices may share and perform the plurality of processing steps. In other words, a plurality of processing steps included in one step can be performed as the processing of a plurality of steps. Reversely, processing described as a plurality of steps can be collectively performed as one step.

Furthermore, for example, in a program that is executed by a computer, the processing of steps describing the program may be executed in time series in the order described in the present specification, or may be executed in parallel or separately at a required time, for example, when a call is made. In other words, the processing of the steps may be performed in an order different from the above-described order if there is no contradiction. Furthermore, the processing of the steps describing this program may be performed in parallel with the processing of another program, or may be performed in combination with the processing of another program.

Moreover, for example, a plurality of techniques regarding the present technique can be independently implemented if there is no contradiction. As a matter of course, a plurality of present techniques may be performed in combination. For example, a part or the entire of the present technique described in any one of the embodiments can be performed in combination with a part or the entire of the present technique described in other embodiments. Alternatively, a part or the entire of any one of the above-described techniques can be performed in combination with other techniques that are not described.

The present technique can also be configured as follows:
(1) An image processing device including: a projection image generation unit that generates a spraying attribute projection image, which is used for spraying for adding an attribute to a geometry in the reconstruction of 3D data in a three-dimensional space, by projecting an attribute of 3D data representing an object in a three-dimensional shape onto a two-dimensional plane independently of the projection of a geometry of the 3D data onto the two-dimensional plane, and a coding unit that codes a frame image in which the spraying attribute projection image is disposed.
(2) The image processing device according to (1), wherein the projection image generation unit generates the spraying attribute projection image by projecting the attribute in a projection direction different from the projection direction of the geometry.
(3) The image processing device according to (2), wherein the projection image generation unit generates the spraying attribute projection image by projecting the attribute onto the two-dimensional plane in such a manner as to form a partial area independent of a partial area of the projection of the geometry.
(4) The image processing device according to (3), wherein the projection image generation unit generates the spraying attribute projection image by projecting the attribute onto the two-dimensional plane such that the partial area of the projection of the attribute crosses a border of the partial area of the projection of the geometry in the reconstruction of the 3D data.
(5) The image processing device according to (4), wherein the projection image generation unit further generates an occupancy map corresponding to the partial area of the projection of the attribute, and
the coding unit further codes the occupancy map.
(6) The image processing device according to any one of (1) to (5), wherein the projection image generation unit generates a base attribute projection image by projecting the attribute in a shape identical to a shape of the projection of the geometry on the two-dimensional plane, and
the coding unit further codes a frame image in which the base attribute projection image is disposed.
(7) The image processing device according to any one of (1) to (6), wherein the coding unit further codes spraying attribute information including identification information about the partial area of the projected attribute, information about the position and size of the partial area on a three-dimensional space, and information about the projection direction of the partial area, the spraying attribute information relating to the spraying attribute projection image.
(8) The image processing device according to (7), wherein the spraying attribute information further includes identification information indicating the spraying attribute projection image.
(9) The image processing device according to (7) or (8), wherein the spraying attribute information further includes information about the control of the spraying.
(10) An image processing method including: generating a spraying attribute projection image, which is used for spraying for adding an attribute to a geometry in the reconstruction of 3D data in a three-dimensional space, by projecting an attribute of 3D data representing an object in a three-dimensional shape onto a two-dimensional plane independently of the projection of a geometry of the 3D data onto the two-dimensional plane, and coding a frame image in which the spraying attribute projection image is disposed.
(11) An image processing device including: a decoding unit that decodes coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image,
a reconstruction unit that reconstructs the 3D data on the geometry in a three-dimensional space on the basis of the coded data on the geometry frame image, and
a spraying unit that performs spraying to add the attribute obtained from the attribute frame image to the 3D data on the geometry in the three-dimensional space on the basis of the position and orientation of the attribute projection image.
(12) The image processing device according to (11), wherein the spraying unit adds the attribute on the attribute projection image to part of the 3D data on the geometry located in the projection direction of the attribute in the three-dimensional space.
(13) The image processing device according to (12), wherein the spraying unit adds the attribute on the attribute projection image to a portion, which is closest to the attribute projection image in the projection direction of the attribute in the three-dimensional space, among the 3D data pieces of the geometry.
(14) The image processing device according to (13), wherein the spraying unit adds the attribute on the attribute projection image to a plurality of portions including the closest portion in the projection direction of the attribute among the 3D data pieces of the geometry.
(15) The image processing device according to (13) or (14), wherein the spraying unit adds the attribute on the attribute projection image to at least a portion, which is located in a predetermined range from the attribute projection image in the projection direction of the attribute, among the 3D data pieces of the geometry.
(16) The image processing device according to any one of (12) to (15), wherein the spraying unit adds the attribute on the attribute projection image to at least one of a geometry generated on the basis of a geometry around a target geometry and the moved target geometry among the 3D data pieces of the geometry.
(17) The image processing device according to any one of (12) to (16), wherein if the plurality of attributes correspond to the single geometry in the three-dimensional space, the spraying unit adds an attribute derived by using the plurality of attributes to the single geometry.
(18) The image processing device according to any one of (12) to (17), wherein if the plurality of attributes correspond to the single geometry in the three-dimensional space, the spraying unit adds one of the plurality of attributes to the single geometry.
(19) The image processing device according to any one of (11) or (18), wherein the decoding unit further decodes coded data on information about the control of the spraying, and the spraying unit adds the attribute to the 3D data on the geometry on the basis of information about the control of the spraying.
(20) An image processing method including: decoding coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image,
reconstructing the 3D data on the geometry in a three-dimensional space on the basis of the coded data on the geometry frame image, and
performing spraying to add the attribute obtained from the attribute frame image to the 3D data on the geometry in the three-dimensional space on the basis of the position and orientation of the attribute projection image.

### REFERENCE SIGNS LIST

300 Coding device
311 Patch generation unit
312 Packing unit
313 Spraying texture generation unit
314 Video frame generation unit
315 Video frame coding unit
316 Auxiliary patch information compression unit
317 Multiplexing unit
321 Projection image generation unit
322 Coding unit
400 Decoding device
411 Demultiplexing unit
412 Video frame decoding unit
413 Unpacking unit
414 Auxiliary patch information decoding unit
415 3D reconstructing unit
416 Spraying unit

1. An image processing device comprising: a projection image generation unit that generates a spraying attribute projection image, which is used for spraying for adding an attribute to a geometry in reconstruction of 3D data in a three-dimensional space, by projecting an attribute of the 3D data representing an object in a three-dimensional shape onto a two-dimensional plane independently of projection of a geometry of the 3D data onto the two-dimensional plane; and
a coding unit that codes a frame image in which the spraying attribute projection image is disposed.

2. The image processing device according to claim 1, wherein the projection image generation unit generates the spraying attribute projection image by projecting the attribute in a projection direction different from a projection direction of the geometry.

3. The image processing device according to claim 2, wherein the projection image generation unit generates the spraying attribute projection image by projecting the attribute onto the two-dimensional plane in such a manner as to form a partial area independent of a partial area of projection of the geometry.

4. The image processing device according to claim 3, wherein the projection image generation unit generates the spraying attribute projection image by projecting the attribute onto the two-dimensional plane such that the partial area of projection of the attribute crosses a border of the partial area of the projection of the geometry in the reconstruction of the 3D data.

5. The image processing device according to claim 4, wherein the projection image generation unit further generates an occupancy map corresponding to the partial area of the projection of the attribute, and
the coding unit further codes the occupancy map.

6. The image processing device according to claim 1, wherein the projection image generation unit generates a base attribute projection image by projecting the attribute in a shape identical to a shape of the projection of the geometry on the two-dimensional plane, and
the coding unit further codes a frame image in which the base attribute projection image is disposed.

7. The image processing device according to claim 1, wherein the coding unit further codes spraying attribute information including identification information about a partial area of the projected attribute, information about a position and size of the partial area on a three-dimensional space, and information about a projection direction of the partial area, the spraying attribute information relating to the spraying attribute projection image.

8. The image processing device according to claim 7, wherein the spraying attribute information further includes identification information indicating the spraying attribute projection image.

9. The image processing device according to claim 7, wherein the spraying attribute information further includes information about control of the spraying.

10. An image processing method comprising: generating a spraying attribute projection image, which is used for spraying for adding an attribute to a geometry in reconstruction of 3D data in a three-dimensional space, by projecting an attribute of the 3D data representing an object in a three-dimensional shape onto a two-dimensional plane independently of projection of a geometry of the 3D data onto the two-dimensional plane; and
coding a frame image in which the spraying attribute projection image is disposed.

11. An image processing device comprising: a decoding unit that decodes coded data on a geometry frame image in which a geometry projection image is disposed, the geometry projection image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image,
a reconstruction unit that reconstructs the 3D data on the geometry in a three-dimensional space on a basis of the coded data on the geometry frame image, and a spraying unit that performs spraying to add the attribute obtained from the attribute frame image to the 3D data on the geometry in the three-dimensional space on a basis of a position and orientation of the attribute projection image.

12. The image processing device according to claim 11, wherein the spraying unit adds the attribute on the attribute projection image to part of the 3D data on the geometry located in a projection direction of the attribute in the three-dimensional space.

13. The image processing device according to claim 12, wherein the spraying unit adds the attribute on the attribute projection image to a closest portion, which is closest to the attribute projection image in the projection direction of the attribute in the three-dimensional space, among 3D data pieces of the geometry.

14. The image processing device according to claim 13, wherein the spraying unit adds the attribute on the attribute projection image to a plurality of portions including the closest portion in the projection direction of the attribute among the 3D data pieces of the geometry.

15. The image processing device according to claim 13, wherein the spraying unit adds the attribute on the attribute projection image to at least a portion, which is located in a predetermined range from the attribute projection image in the projection direction of the attribute, among the 3D data pieces of the geometry.

16. The image processing device according to claim 12, wherein the spraying unit adds the attribute on the attribute projection image to at least one of a geometry generated on the basis of a geometry around a target geometry and the moved target geometry among the 3D data pieces of the geometry.

17. The image processing device according to claim 12, wherein if the plurality of attributes correspond to the single geometry in the three-dimensional space, the spraying unit adds an attribute derived by using the plurality of attributes to the single geometry.

18. The image processing device according to claim 12, wherein if the plurality of attributes correspond to the single geometry in the three-dimensional space, the spraying unit adds one of the plurality of attributes to the single geometry.

19. The image processing device according claim 11, wherein the decoding unit further decodes coded data on information about control of the spraying, and the spraying unit adds the attribute to the 3D data on the geometry on a basis of information about the control of the spraying.

20. An image processing method comprising: decoding coded data on a geometry frame image in which a geometry projection image is disposed, the geometry frame image being projected on a two-dimensional plane representing a geometry of 3D data on an object having a three-dimensional shape, and coded data on an attribute frame image in which an attribute projection image representing an attribute of the 3D data is disposed, the 3D data being projected on a two-dimensional plane independent of the two-dimensional plane of the geometry projection image,
reconstructing the 3D data on the geometry in a three-dimensional space on a basis of the coded data on the geometry frame image, and
performing spraying to add the attribute obtained from the attribute frame image to the 3D data on the geometry in the three-dimensional space on a basis of a position and orientation of the attribute projection image.
